(19) United States
(12) Patent Application Publication
(10) Pub. No.: US 2016/0124200 A1
(43) Pub. Date: May 5, 2016

(54) ZOOM LENS AND IMAGING APPARATUS

(71) Applicant: TAMRON CO., LTD., Saitama-shi (JP)

(72) Inventors: Yasuhiko OBIKANE, Saitama-shi (JP); Koichiro YOKOTA, Saitama-shi (JP)

(73) Assignee: TAMRON CO., LTD., Saitama-shi (JP)

(21) Appl. No.: 14/829,976

(22) Filed: Aug. 19, 2015

(30) Foreign Application Priority Data
Oct. 31, 2014 (JP) 2014-223537

(51) Int. Cl. G02B 15/20; G02B 27/00; H04N 5/225; H04N 5/232; G02B 13/00; G02B 27/64; G02B 15/177

(52) U.S. Cl. CPC G02B 15/20; G02B 27/646; G02B 27/0025; G02B 15/177; H04N 5/23296; G02B 13/009; H04N 5/2254; H04N 5/23212

(57) ABSTRACT

A zoom lens includes sequentially from an object side a first lens group having a negative refractive power; a second lens group having a positive refractive power; a third lens group having a negative refractive power; and a fourth lens group having a negative refractive power. The first lens group, the second lens group, the third lens group, and the fourth lens group are moved along an optical axis to zoom from a wide angle end to telephoto end and such that an interval between the first lens group and the second lens group decreases and distances that the second lens group and the fourth lens group are moved are equivalent. The third lens group is moved along the optical axis, toward an image side to focus from a focused state at infinity to a focused state at a minimum object distance.

### BACKGROUND OF THE INVENTION

1. Field of the Invention

The present invention relates to a zoom lens and an imaging apparatus equipped with the zoom lens.

2. Description of the Related Art

Conventionally, lenses for single-lens reflex cameras, in particular, have to establish a long flange focal length with respect to the focal length and often adopt a configuration that enables back focus to be established easily by disposing a positive lens group at the rear of the optical system. Nonetheless, with increasingly smaller camera bodies and the prevalence of digital cameras in recent years, instances where a long flange focal length is not necessary are increasing. Thus, zoom lenses have been proposed that have a relatively short back focus to enable mounting to a small-sized camera (for example, refer to Japanese Patent No. 3018803 and Japanese Patent Application Laid-Open Publication Nos. S63-58325, 2012-226307, and 2012-198505).

Further, since capturing video is also possible by a digital camera, high-speed autofocus processing for capturing video is desirable. A portion of a lens group (focusing group) is vibrated rapidly along the optical axis (wobble) to achieve transitions: a non-focused state→focused state→non-focused state. A signal component of a specific frequency bandwidth of a partial image area is detected from the output signal of the image sensor; an optimal position of the focusing group achieving a focused state is determined; and the focusing group is moved to the optimal position. In particular, when video is captured, this series of operations has to be successively repeated rapidly. Further, in the execution of wobble, rapid driving of the focusing group has to be possible and the focusing group is demanded to have the smallest diameter possible and to be light-weight.

In particular, when wobble is introduced, the size of the image that corresponds to the object during wobbling changes. This phenomenon is primarily is caused by a change in the focal length of the entire optical system consequent to the movement of the focusing group along the optical axis; and when the change in the reproduction ratio is large consequent to variations in the angle of view during wobbling, the image seems odd. The extent to which the image seems odd can be reduced by using a rear lens group to perform focusing with respect to the aperture. In addition, wobbling requires rapid driving of the focusing group and thus, requires the focusing group to be light-weight and to have the smallest diameter possible.

Often when video is captured, the direction of the camera is changed and/or the user has to move to follow the behavior of the object and therefore, image blur is prone to occur. Thus, it is desirable to equip the imaging lens with a stabilizing group that corrects for vibration. Even when a stabilizing group is disposed, to perform effective vibration correction, the stabilizing group has to be driven rapidly and has to have a small diameter and be light-weight.

Further, in an image sensor that optically receives optical images and converts the optical images into electrical image signals, conventionally, there is a limit for efficiently taking in incident light by an on-chip microlens, etc. and it is desirable to increase the exit pupil on the lens side to a given size or greater and establish telecentricity of the light beam incident on the image sensor.

Nonetheless, with recent image sensors, the aperture ratio has improved and the degree of freedom in the design of on-chip microlenses has advanced. Consequently, the limits of the exit pupil demanded on the imaging lens side have decreased. Therefore, with conventional imaging lenses, a positive lens is disposed at the rear of the optical system and telecentricity is established; however, this is no longer necessary and even if there is oblique incidence of the light beam on the image sensor when a negative lens is disposed at the rear of the optical system, limb darkening (shading) such as pupil mismatch with the on-chip microlens has become less noticeable. Thus, since it is no longer necessary to establish telecentricity of the light beam incident on the image sensor, oblique incidence of light beam on the image sensor has become advantageous in reducing the size of the imaging lens. Further, there have been advances and improvements of software and camera systems and although distortion is somewhat large, even that which was serious conventionally, can be corrected by image processing.

Nonetheless, it is difficult to say that conventional zoom lenses have achieved sufficient size reductions on par with the extent to which cameras have been reduced in size. Further, it is hard to say that currently, irrespective of the wide prevalence of digital cameras that can record video, a zoom lens has been provided that has sufficiently reduced the size of the focusing group and the stabilizing group, is light-weight, and can record video favorably.

For example, in the embodiments described in Japanese Patent No. 3018803 and Japanese Patent Application Laid-Open Publication Nos. S63-58325 and 2012-226307, zoom lenses are disclosed that have 4 lens groups having sequentially from the object side, negative, positive, negative, and negative refractive powers. In these zoom lenses, the distance that a second lens group and a fourth lens group are moved during zooming are made equal whereby, the second lens group to the fourth lens group form an integral structure, enabling simplification of the mechanisms of the lens barrel. Nonetheless, during focusing from infinity to a close range subject, moving a third lens group, which has the smallest effective diameter, to perform focusing is difficult.

Therefore, when performing focusing, the zoom lens disclosed in Japanese Patent No. 3018803 has to extend the entire optical system or extend a first lens group. As a result, the zoom lens runs the risk of changes in the reproduction ratio becoming large consequent to variation of the angle of view during wobbling since the focusing group is large, has significant weight, and is not suitable for recording video since high-speed focusing is difficult.

Further, in first and second embodiments described in Japanese Patent Application Laid-Open Publication No. S63-58325, zoom lenses are disclosed that have 4 lens groups having sequentially from the object side, negative, positive, negative, and negative refractive powers. In these zoom lenses, a fourth lens group is fixed during zooming, enabling simplification of the mechanisms of the lens barrel. Nonetheless, during focusing from infinity to a close range subject, moving a third lens group, which has the smallest effective diameter, to perform focusing is difficult.

Therefore, the zoom lens disclosed in Japanese Patent Application Laid-Open Publication No. S63-58325, similar to the zoom lens disclosed in Japanese Patent No. 3018803, has to extend the entire optical system or extend a first lens group when performing focusing. As a result, this zoom lens also runs the risk of changes in the reproduction ratio becoming large consequent to variation of the angle of view during wobbling since the focusing group is large, has significant weight, and thus, is not suitable for recording video since high-speed focusing is difficult.

In an eighth embodiment disclosed in Japanese Patent Application Laid-Open Publication No. 2012-226307, a zoom lens is disclosed that has 4 lens groups having sequentially from the object side, negative, positive, negative, and negative refractive powers. In this zoom lens, a fourth lens group is fixed during zooming, enabling simplification of the mechanisms of the lens barrel and during focusing from infinity to a close range subject, focusing can be performed by moving a third lens group, which has the smallest effective diameter.

Nonetheless, in the zoom lens disclosed in Japanese Patent Application Laid-Open Publication No. 2012-226307, a second lens group and the fourth lens group are not fixed, making it difficult to keep shifting of the lens centers of the second lens group and the fourth lens group to a minimum and therefore, degradation of optical performance consequent to manufacturing error at the time of assembly may become serious. Further, since the lateral magnification of the fourth lens group at the telephoto end, in particular, becomes small, the overall length of the optical system becomes long since the focal length of the optical system before the fourth lens group cannot be made small and the telephoto ratio is not sufficiently achieved. Furthermore, the stabilizing group, which is moved orthogonally with respect to the optical axis to correct blur, is also used as a zoom element and therefore, reductions in the size and weight of the stabilizing group are difficult.

In a fifth embodiment described in Japanese Patent Application Laid-Open Publication No. 2012-198505, a zoom lens is disclosed that has 4 lens groups having sequentially from the object side, negative, positive, negative, and positive refractive powers. In this zoom lens, a fourth lens group is fixed, enabling simplification of the mechanisms of the lens barrel and during focusing from infinity to a close range subject, focusing can be performed by moving a third lens group, which has the smallest effective diameter.

Nonetheless, in the zoom lens disclosed in Japanese Patent Application Laid-Open Publication No. 2012-198505, a second lens group and the fourth lens group are not fixed to one another, making it difficult to keep shifting of the lens centers of the second lens group and the fourth lens group to a minimum and therefore, degradation of optical performance consequent to manufacturing error may become serious. Further, since the lateral magnification of the fourth lens group at the telephoto end, in particular, becomes small, the overall length of the optical system becomes long since the focal length of the optical system before the fourth lens group cannot be made small and the telephoto ratio is not sufficiently achieved.

### SUMMARY OF THE INVENTION

It is an object of the present invention to at least solve the above problems in the conventional technologies.

A zoom lens includes sequentially from an object side a first lens group having a negative refractive power; a second lens group having a positive refractive power; a third lens group having a negative refractive power; and a fourth lens group having a negative refractive power. The first lens group, the second lens group, the third lens group, and the fourth lens group are moved along an optical axis to zoom from a wide angle end to telephoto end and such that an interval between the first lens group and the second lens group decreases and distances that the second lens group and the fourth lens group are moved are equivalent. The third lens group is moved along the optical axis, toward an image side to focus from a focused state at infinity to a focused state at a minimum object distance.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram depicting, along the optical axis, a configuration of a zoom lens according to a first embodiment;

FIG. 2 is a diagram of various types of longitudinal aberration occurring in the zoom lens according to the first embodiment;

FIGS. 3A and 3B are diagrams of various types of transverse aberration occurring at a telephoto end of the zoom lens according to the first embodiment;

FIG. 4 is a diagram depicting, along the optical axis, a configuration of the zoom lens according to a second embodiment;

FIG. 5 is a diagram of various types of longitudinal aberration occurring in the zoom lens according to the second embodiment;

FIGS. 6A and 6B are diagrams of various types of transverse aberration occurring at the telephoto end of the zoom lens according to the second embodiment;

FIG. 7 is a diagram depicting, along the optical axis, a configuration of the zoom lens according to a third embodiment;

FIG. 8 is a diagram of various types of longitudinal aberration occurring in the zoom lens according to the third embodiment;

FIGS. 9A and 9B are diagrams of various types of transverse aberration occurring at the telephoto end of the zoom lens according to the third embodiment;

FIG. 10 is a diagram depicting, along the optical axis, a configuration of the zoom lens according to a fourth embodiment;

FIG. 11 is a diagram of various types of longitudinal aberration occurring in the zoom lens according to the fourth embodiment;

FIGS. 12A and 12B are diagrams of various types of transverse aberration occurring at the telephoto end of the zoom lens according to the fourth embodiment;

FIG. 13 is a diagram depicting, along the optical axis, a configuration of the zoom lens according to a fifth embodiment;

FIG. 14 is a diagram of various types of longitudinal aberration occurring in the zoom lens according to the fifth embodiment;

FIGS. 15A and 15B are diagrams of various types of transverse aberration occurring at the telephoto end of the zoom lens according to the fifth embodiment;

FIG. 16 is a diagram depicting, along the optical axis, a configuration of the zoom lens according to a sixth embodiment;

FIG. 17 is a diagram of various types of longitudinal aberration occurring in the zoom lens according to the sixth embodiment;

FIGS. 18A and 18B are diagrams of various types of transverse aberration occurring at the telephoto end of the zoom lens according to the sixth embodiment;

FIG. 19 is a diagram depicting, along the optical axis, a configuration of the zoom lens according to a seventh embodiment;

FIG. 20 is a diagram of various types of longitudinal aberration occurring in the zoom lens according to the seventh embodiment;

FIGS. 21A and 21B are diagrams of various types of transverse aberration occurring at the telephoto end of the zoom lens according to the seventh embodiment; and

FIG. 22 is a diagram depicting an application example of an imaging apparatus equipped with the zoom lens according to the present invention.

### DETAILED DESCRIPTION OF THE PREFERRED EMBODIMENTS

Preferred embodiments of a zoom lens and an imaging apparatus according to the present invention will be described in detail with reference to the accompanying drawings.

The zoom lens according to the present invention has the following characteristics.

The zoom lens has sequentially from an object side, a first lens group having a negative refractive power, a second lens group having a positive refractive power, a third lens group having a negative refractive power, and a fourth lens group having a negative refractive power. The first lens group, the second lens group, the third lens group, and the fourth lens group are moved along an optical axis such that an interval between the first lens group and the second lens group becomes small and the respective distances that the second lens group and the fourth lens group are moved are equivalent, whereby zooming from a wide angle end to a telephoto end is performed, and focusing from a focused state at infinity to a focused state at the minimum object distance is performed by moving the third lens group along the optical axis, toward the image side.

In the zoom lens, both the third lens group and the fourth lens group are negative lens groups, whereby a telephoto ratio is realized in the optical system overall and the overall length of the optical system is shortened. As a result, the distance that the third lens group is moved during focusing can be suppressed and changes in the reproduction ratio consequent to variation of the angle of view during wobbling can be suppressed.

Further, by making the distances that the second lens group and the fourth lens group are moved during zooming equivalent (movement loci of the second lens group and the fourth lens group have the same shape), the second lens group and the fourth lens group can be an integrated structure using a lens frame, and the like. This integrated structure enables simplification of the cam structure that controls the zoom ratio in the lens barrel and enables the maximum diameter of the lens barrel to be made smaller. Further, shifting of the lens centers of the second lens group and of the fourth lens group with respect to one another, potentially occurring with zooming, can be kept to a minimum and degradation of optical performance consequent to manufacturing error at the time of assembly can be suppressed. If the second lens group and the fourth lens group have an integrated structure using, for example, a lens frame, the assembly process of the zoom lens can be simplified, whereby adjustment of the positions of the lens groups to suppress manufacturing error in the zoom lens is facilitated and the manufacturing cost of the zoom lens can be suppressed.

The third lens group, which is the focusing group, is disposed on the image side of the second lens group. Since the second lens group has a positive refractive power, the diameter of the third lens group, which is disposed at a position where the diameter of the light beam is made smaller by the second lens group (image side of second lens group), can be made smaller. Therefore, reductions in the size and weight of the focusing group become possible, enabling fast wobbling and high-speed focusing. Reduction of the lens barrel diameter also becomes possible.

Here, the third lens group, which is the focusing group, is preferably configured by a single lens element. The single lens element includes, for example, a single ground lens or aspheric lens, a compound aspheric lens, or a cemented lens and does not include, for example, 2 positive/negative lenses that are not attached to one another and have an air gap therebetween. The weight of the focusing group can be further reduced by such a configuration, whereby load on the autofocus mechanism that drives the focusing group is reduced, enabling faster focusing. The power consumed for focusing can also be reduced.

Typically, the aperture stop (optical aperture) is preferably between the object side of the second lens group and the image side of the third lens group to cut light rays before and after the aperture stop. However, in the present invention, since the third lens group is used as the focusing group, a configuration in which the aperture stop moves with the third lens group is not desirable to execute high-speed focusing. Thus, in the zoom lens according to the present invention, a configuration is adopted where the aperture stop is in the second lens group or in a vicinity of second lens group, and moves with the second lens group during zooming.

The zoom lens preferably satisfies the following condition, where β4T is lateral magnification of the fourth lens group at the telephoto end.

1.06≦β4T≦3.00 (1)

Conditional expression (1) prescribes lateral magnification of the fourth lens group at the telephoto end. Satisfying conditional expression (1) enables the overall length of the optical system to be shortened. In addition, shifting of the lens centers of the fourth lens group and of another lens group with respect to one another, potentially occurring with zooming, can be suppressed, enabling favorable optical performance to be maintained.

Below the lower limit of conditional expression (1), it becomes difficult to shorten the focal length from the first lens group to the third lens group and as a result, the overall length of the optical system at the telephoto end cannot be shortened. Meanwhile, above the upper limit of conditional expression (1), lateral magnification of the fourth lens group at the telephoto end becomes large and the power becomes too strong, whereby shifting of the lens centers of the fourth lens group and of another group with respect to one another is prone to occur with zooming and degradation of optical performance consequent to manufacturing error at the time of assembly may become serious.

An even more desirable effect can be expected by satisfying conditional expression (1) to be within the following range.

1.10≦β4T≦2.50 (1a)

Satisfying the range prescribed by conditional expression (1a) facilitates both shortening of the overall length of the optical system and maintenance of favorable optical performance.

An even more desirable effect can be expected by satisfying conditional expression (1a) to be within the following range.

1.14≦β4T≦2.00 (1b)

Satisfying the range prescribed by conditional expression (1b) facilitates both shortening of the overall length of the optical system and maintenance of favorable optical performance.

The zoom lens preferably satisfies the following conditional expression, where f4 is the focal length of the fourth lens group, fw is the focal length of the entire optical system at the wide angle end, and ft is the focal length of the entire optical system at the telephoto end.

$$1.20 \leq \frac{\vert f 4 \vert}{\sqrt{( fw \times f t} )} \leq 10.00 \qquad ( 2 )$$

Conditional expression (2) prescribes the focal length of the fourth lens group for the effective focal length of the entire optical system. The overall length of the optical system can be shortened by satisfying conditional expression (2). In addition, shifting of the lens centers of the fourth lens group and of another lens group with respect to one another, potentially occurring with zooming, can be suppressed, enabling favorable optical performance to be maintained.

Below the lower limit of conditional expression (2), the power of the fourth lens group becomes too strong, whereby shifting of the lens centers of the fourth lens group and of another group with respect to one another is prone to occur with zooming and degradation of optical performance consequent to manufacturing error at the time of assembly may become serious. Meanwhile, above the upper limit of conditional expression (2), the power of the fourth lens group becomes too weak, whereby the telephoto ratio cannot be sufficiently achieved in the optical system overall and as a result, the overall length of the optical system cannot be shortened.

An even more desirable effect can be expected by satisfying conditional expression (2) to be within the following range.

$$1.30 \leq \frac{\vert f 4 \vert}{\sqrt{( fw \times f t} )} \leq 9.00 \qquad ( 2 a )$$

Satisfying the range prescribed by conditional expression (2a) facilitates both shortening of the overall length of the optical system and maintenance of favorable optical performance.

An even more desirable effect can be expected by satisfying conditional expression (2a) to be within the following range.

$$1.40 \leq \frac{\vert f 4 \vert}{\sqrt{( fw \times f t} )} \leq 8.00 \qquad ( 2 b )$$

Satisfying the range prescribed by conditional expression (2b) facilitates both shortening of the overall length of the optical system and maintenance of favorable optical performance.

The zoom lens preferably satisfies the following conditional expression, where f3 is the focal length of the third lens group, fw is the focal length of the entire optical system at the wide angle end, and ft is the focal length of the entire optical system at the telephoto end.

$$0.70 \leq \frac{\vert f 3 \vert}{\sqrt{( fw \times f t} )} \leq 5.00 \qquad ( 3 )$$

Conditional expression (3) prescribes the focal length of the third lens group for the effective focal length of the entire optical system. The overall length of the optical system can be shortened by satisfying conditional expression (3). Further, changes in the reproduction ratio consequent to variation of the angle of view during wobbling can be suppressed and favorable high-speed focusing can be performed by suppressing the distance that the third lens group is moved during focusing. The correction of various types of aberration during focusing also becomes favorable.

Below the lower limit of conditional expression (3), the power of the third lens group becomes too strong, whereby changes in the reproduction ratio consequent to variation of the angle of view during wobbling become large, posing a particular obstacle to capturing video and making aberration correction of field curvature variation during focusing difficult. Meanwhile, above the upper limit of conditional expression (3), the power of the third lens group becomes too weak, whereby the distance that the third lens group is moved during focusing cannot be suppressed, posing a problem in performing high-speed focusing. In addition, the telephoto ratio cannot be sufficiently achieved in the optical system overall and as a result, the overall length of the optical system cannot be shortened.

An even more desirable effect can be expected by satisfying conditional expression (3) to be within the following range.

$$0.80 \leq \frac{\vert f 3}{\sqrt{( fw \times f t )}} \leq 4.00 \qquad ( 3 a )$$

Satisfying the range prescribed by conditional expression (3a) facilitates both shortening of the overall length of the optical system and maintenance of favorable optical performance. High-speed focusing is also facilitated.

An even more desirable effect can be expected by satisfying conditional expression (3a) to be within the following range.

$$0.90 \leq \frac{\vert f 3}{\sqrt{( fw \times f t )}} \leq 3.00 \qquad ( 3 b )$$

Satisfying the range prescribed by conditional expression (3b) facilitates both shortening of the overall length of the optical system and maintenance of favorable optical performance. High-speed focusing is also facilitated.

The zoom lens has the following characteristics in addition to those above.

The zoom lens has a stabilizing group in the second lens group. The stabilizing group is moved in a direction that is substantially orthogonal to the optical axis and corrects blur. Here, the stabilizing group is preferably configured by a single lens element. The single lens element includes, for example, a single ground lens or aspheric lens, a compound aspheric lens, or a cemented lens and does not include, for example, 2 positive/negative lenses that are not attached to one another and have an air gap therebetween. Reductions in the size and weight of the stabilizing group can be facilitated by such a configuration. Reduction of the size of the stabilizing group facilitates a reduction in the size of the lens barrel. Further, reduction of the weight of the stabilizing group reduces the load on the stabilizing mechanism that drives the stabilizing group, enabling rapid correction of blur and reduced power consumption by the stabilizing mechanism.

Assuming that the second lens group includes the stabilizing group, the zoom lens preferably satisfies the following conditional expression, where fv is the focal length of the stabilizing group, fw is the focal length of the entire optical system at the wide angle end, and ft is the focal length of the entire optical system at the telephoto end.

$$0.30 \leq \frac{fv}{\sqrt{( fw \times f t )}} \leq 1.10 \qquad ( 4 )$$

Conditional expression (4) prescribes the focal length of the stabilizing group for the effective focal length of the entire optical system. A compact, high-performance zoom lens having a small, light-weight stabilizing group can be realized by satisfying conditional expression (4).

Below the lower limit of conditional expression (4), the power of the stabilizing group becomes too strong, whereby the correction of various types of aberration at the time of blur correction becomes difficult. In this case, to correct aberration, the number of lenses configuring the stabilizing group has to be increased and as a result, reduction of the weight of the stabilizing group becomes difficult. Meanwhile, above the upper limit of conditional expression (4), the power of the stabilizing group becomes too weak, whereby the distance that the stabilizing group is moved when correcting blur increases as does the effective aperture. Consequently, reduction of the diameter of the lens barrel becomes difficult.

An even more desirable effect can be expected by satisfying conditional expression (4) to be within the following range.

$$0.40 \leq \frac{fv}{\sqrt{( fw \times f t )}} \leq 1.00 \qquad ( 4 a )$$

Satisfying the range prescribed by conditional expression (4a) facilitates further reductions of the size and weight of the stabilizing group and further reduction of the effective aperture while maintaining favorable optical performance.

An even more desirable effect can be expected by satisfying conditional expression (4a) to be within the following range.

$$0.50 \leq \frac{fv}{\sqrt{( fw \times f t )}} \leq 0.90 \qquad ( 4 b )$$

Satisfying the range prescribed by conditional expression (4b) facilitates even further reductions in the size and weight of the stabilizing group as well as in the diameter of the effective aperture while maintaining favorable optical performance.

The zoom lens is configured as described above, whereby the overall length of the optical system is shortened and the distance that the focusing group is moved during focusing is suppressed, thereby enabling changes in the reproduction ratio consequent to variation of the angle of view during wobbling to be suppressed. Further, reductions in the size and weight of the focusing group are facilitated, enabling favorable high-speed focusing. The correction of various types of aberration during focusing becomes favorable. Furthermore, shifting of lens centers of lens groups with respect to one another, potentially occurring with zooming, can be kept to a minimum and degradation of optical performance consequent to manufacturing error at the time assembly can be suppressed. Facilitating reductions in the size and weight of the stabilizing group enables favorable optical performance to be maintained even during blur correction. A reduction of the diameter of the optical system is also possible.

The imaging apparatus according to the present invention is configured by the zoom lens configured as described above and an image sensor that optically receives the image formed by the zoom lens. With such a configuration, an imaging apparatus that has a compact, high-performance zoom lens and that is also suitable for capturing video can be realized.

Embodiments of the zoom lens according to the present invention will be described in detail with reference to the accompanying drawings. The present invention is not limited by the embodiments hereinafter.

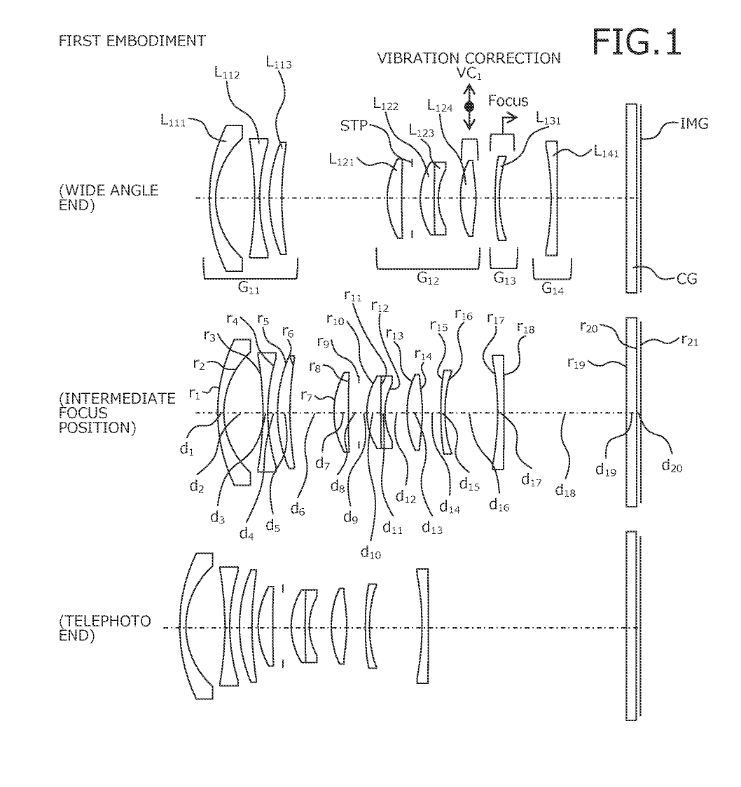

FIG. 1 is a diagram depicting, along the optical axis, a configuration of the zoom lens according to a first embodiment. The zoom lens includes sequentially from the object side nearest a non-depicted object, a first lens group G₁₁ having a negative refractive power, a second lens group G₁₂ having a positive refractive power, a third lens group G₁₃ having a negative refractive power, and a fourth lens group G₁₄ having a negative refractive power. A cover glass CG is disposed between the fourth lens group G₁₄ and the image plane IMG.

The first lens group G₁₁ includes sequentially from the object side, a negative lens L₁₁₁, a negative lens L₁₁₂, and a positive lens L₁₁₃.

The second lens group G₁₂ includes sequentially from the object side, a positive lens L₁₂₁, an aperture stop STP prescribing a given aperture, a positive lens L₁₂₂, a negative lens L₁₂₃, and positive lens L₁₂₄. Both surfaces of the positive lens L₁₂₁ and of the positive lens L₁₂₄ are aspheric. The positive lens L₁₂₂ and the negative lens L₁₂₃ are cemented.

The third lens group G₁₃ is configured by a negative lens L₁₃₁. Both surfaces of the negative lens L₁₃₁ are aspheric.

The fourth lens group G₁₄ is configured by a negative lens L₁₄₁.

In the zoom lens, the second lens group G₁₂, the third lens group G₁₃, and the fourth lens group G₁₄ are moved along the optical axis, from the image plane IMG side toward the object side during zooming from the wide angle end to the telephoto end. During zooming, the second lens group G₁₂ and the fourth lens group G₁₄ move along loci of the same shape such that the respective distances moved by the second lens group G₁₂ and the fourth lens group G₁₄ are equal. From the wide angle end to an intermediate focus position, the first lens group G₁₁ moves along the optical axis, from the object side toward the image plane IMG side by a convex locus; and from a vicinity of an intermediate focus position to the telephoto end, the first lens group G₁₁ moves along the optical axis, from the image plane IMG side toward the object side. The interval between the first lens group G₁₁ and the second lens group G₁₂ decreases during zooming from the wide angle end to the telephoto end.

In the zoom lens, focusing from a focused state at infinity to a focused state at the minimum object distance is performed by moving the third lens group G₁₃ along the optical axis, from the object side toward the image plane IMG side. Further, the positive lens L₁₂₄ in the second lens group G₁₂ functions as a stabilizing group VC₁ and blur is corrected by moving the stabilizing group VC₁ in a direction that is substantially orthogonal to the optical axis.

Here, values of various types of data related to the zoom lens according to the first embodiment are given.

F number=3.61 (wide angle end) to 5.00 (intermediate focus position) to 5.77 (telephoto end)
Focal length of entire zoom lens system=28.92 (fw: wide angle end) to 45.05 (intermediate focus position) to 67.85 (ft: telephoto end)
Half angle of view (ω)=37.93 (wide angle end) to 25.88 (intermediate focus position) to 17.67 (telephoto end)

(Lens data)

| | | | |
|---|---|---|---|
| r₁ = 39.922 | d₁ = 1.500 | nd₁ = 1.9108 | νd₁ = 35.25 |
| r₂ = 19.402 | d₂ = 9.507 | | |
| r₃ = −79.046 | d₃ = 1.200 | nd₂ = 1.4875 | νd₂ = 70.44 |
| r₄ = 44.147 | d₄ = 2.348 | | |
| r₅ = 33.96 | d₅ = 3.060 | nd₃ = 1.8467 | νd₃ = 23.78 |
| r₆ = 79.327 | d₆ = D(6) | | |
| | (variable) | | |
| r₇ = 18.821 | d₇ = 3.495 | nd₄ = 1.5533 | νd₄ = 71.68 |
| (aspheric) | | | |
| r₈ = 216.928 | d₈ = 2.537 | | |
| (aspheric) | | | |
| r₉ = ∞ | d₉ = 2.000 | | |
| (aperture stop) | | | |
| r₁₀ = 16.388 | d₁₀ = 3.400 | nd₅ = 1.4970 | νd₅ = 81.61 |
| r₁₁ = 246.603 | d₁₁ = 1.000 | nd₆ = 1.8061 | νd₆ = 40.73 |
| r₁₂ = 14.368 | d₁₂ = 5.372 | | |
| r₁₃ = 23.633 | d₁₃ = 3.744 | nd₇ = 1.4971 | νd₇ = 81.56 |
| (aspheric) | | | |
| r₁₄ = −36.371 | d₁₄ = D(14) | | |
| (aspheric) | (variable) | | |
| r₁₅ = 67.524 | d₁₅ = 1.000 | nd₈ = 1.5312 | νd₈ = 56.04 |
| (aspheric) | | | |
| r₁₆ = 30.916 | d₁₆ = D(16) | | |
| (aspheric) | (variable) | | |
| r₁₇ = −64.918 | d₁₇ = 1.500 | nd₉ = 1.5168 | νd₉ = 64.20 |
| r₁₈ = −1428.629 | d₁₈ = D(18) | | |
| | (variable) | | |
| r₁₉ = ∞ | d₁₉ = 2.500 | nd₁₀ = 1.5168 | νd₁₀ = 64.20 |
| r₂₀ = ∞ | d₂₀ = 1.000 | | |
| r₂₁ = ∞ | | | |
| (image plane) | | | |

Constant of the conic (k) and aspheric coefficients (A₄, A₆, A₈, A₁₀)
(Seventh order)
k = 0, A₄ = −4.3658 × 10⁻⁶, A₆ = −1.7461 × 10⁻⁸, A₈ = 7.9260 × 10⁻¹⁰,
A₁₀ = −1.4788 × 10⁻¹¹
(Eighth order)
k = 0, A₄ = 8.4072 × 10⁻⁶, A₆ = 3.7552 × 10⁻⁸, A₈ = −3.5298 × 10⁻¹⁰,
A₁₀ = −9.2526 × 10⁻¹²
(Thirteenth order)
k = 0, A₄ = 1.4846 × 10⁻⁵, A₆ = 1.6458 × 10⁻⁷, A₈ = −1.1294 × 10⁻⁹,
A₁₀ = 1.4522 × 10⁻¹¹
(Fourteenth order)
k = 0, A₄ = 3.4763 × 10⁻⁵, A₆ = 1.9866 × 10⁻⁷, A₈ = −7.6839 × 10⁻¹⁰,
A₁₀ = 1.4749 × 10⁻¹¹
(Fifteenth order)
k = 0, A₄ = −2.5602 × 10⁻⁵, A₆ = 9.2556 × 10⁻⁸, A₈ = 3.1340 × 10⁻⁹,
A₁₀ = −8.3890 × 10⁻¹²
(Sixteenth order)
k = 0, A₄ = −2.4171 × 10⁻⁵, A₆ = 1.7674 × 10⁻⁷, A₈ = 1.7772 × 10⁻⁹,
A₁₀ = 1.8120 × 10⁻¹²

(Zoom data)

| | | Intermediate | |
|---|---|---|---|
| | Wide angle end | focus position | Telephoto end |
| D(6) | 25.656 | 10.665 | 1.500 |
| D(14) | 4.700 | 4.459 | 4.540 |
| D(16) | 12.640 | 12.881 | 12.800 |
| D(18) | 16.841 | 29.836 | 48.190 |

(Values related to conditional expression (1))
β4T (lateral magnification of fourth lens group G₁₄ at telephoto end)=1.393
(Values related to conditional expression (2))
f4 (focal length of fourth lens group G₁₄)=−131.645

$$\frac{\vert f 4 \vert}{\sqrt{( fw \times f t )}} = 2.972$$

(Values related to conditional expression (3))
f3 (focal length of third lens group G₁₃)=−108.388

$$\frac{\vert f 3 \vert}{\sqrt{( fw \times f t )}} = 2.447$$

(Values related to conditional expression (4))
fv (focal length of stabilizing group VC₁)=29.427

$$\frac{fv}{\sqrt{( fw \times f t )}} \leq 0.664$$

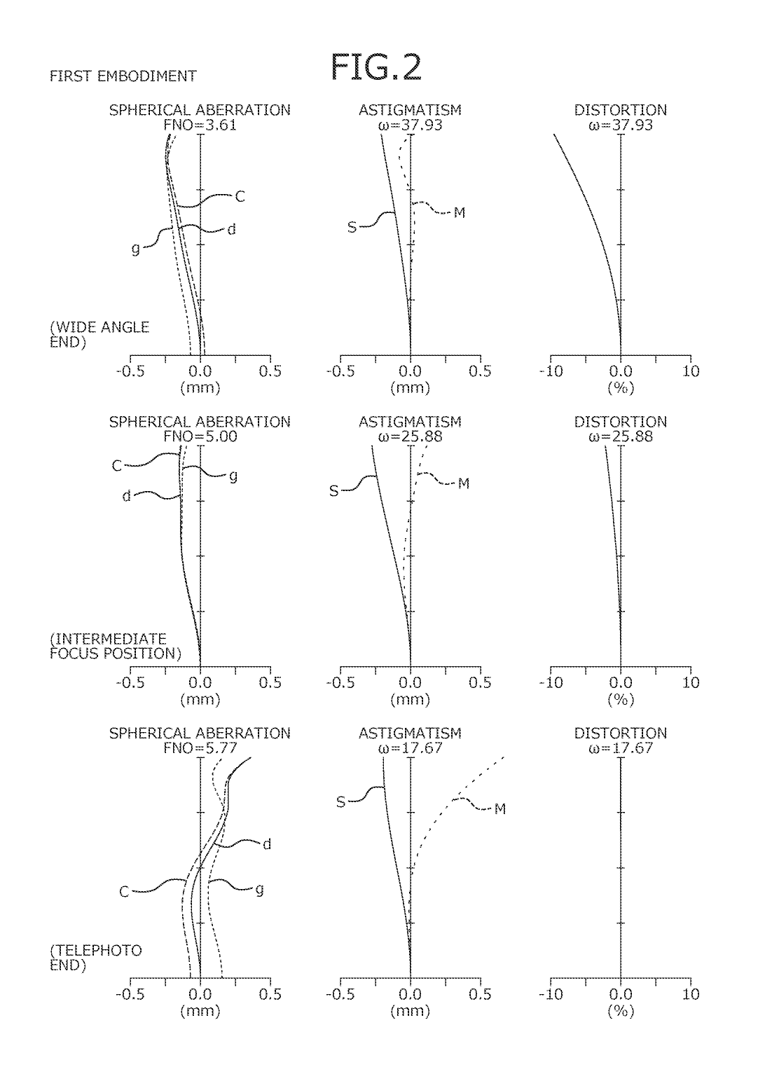

FIG. 2 is a diagram of various types of longitudinal aberration occurring in the zoom lens according to the first embodiment. In the diagram, for curves depicting spherical aberration, the vertical axis represents the F number (FNO), solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to the c-line (λ=656.28 nm). For curves depicting astigmatism, the vertical axis represents the half angle of view (ω), solid lines depict characteristics of the sagittal plane (S), and dashed lines depict characteristics of the meridional plane (M). For curves depicting distortion, the vertical axis represents the half angle of view (ω).

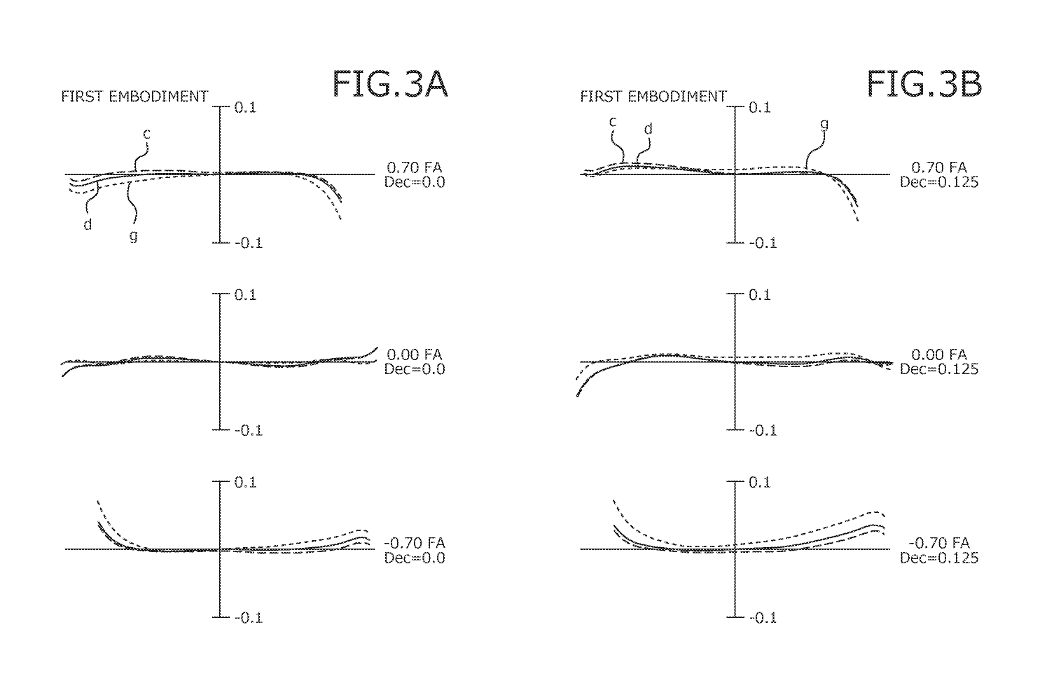

FIGS. 3A and 3B are diagrams of various types of transverse aberration occurring at the telephoto end of the zoom lens according to the first embodiment. FIG. 3A depicts a reference state where blur is not corrected at the telephoto end and FIG. 3B depicts a state where blur is corrected at the telephoto end, by moving the stabilizing group VC₁ 0.125 mm in a direction that is substantially orthogonal to the optical axis. Image displacement when the object distance is ∞ and the zoom lens is tilted 0.3 degrees at the telephoto end is equivalent to the image displacement when the stabilizing group VC₁ is moved 0.125 mm parallel to the direction that is substantially orthogonal to the optical axis.

In FIGS. 3A and 3B, an upper portion depicts transverse aberration at an image point corresponding to 70% of the maximum image height, a middle portion depicts transverse aberration at an image point on the optical axis, and a lower portion depicts transverse aberration at an image point corresponding to −70% of the maximum image height. In the figures, the horizontal axis represents the distance from the principal ray on the pupil plane, solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to the c-line (λ=656.28 nm).

From the figures depicting transverse aberration, it is clear that the symmetry of the transverse aberration at the image point on the axis is favorable. Further, comparison of the transverse aberration at the +70% image point and the transverse aberration at the −70% image point with the reference state reveals that for both, curvature is minimal and since the slopes of the aberration curves are substantially equivalent, eccentric comatic aberration and eccentric astigmatism are minimal, indicating that even in a state where blur is corrected, sufficient imaging performance can be obtained.

Further, when the blur correction angles of the zoom lens are the same, the focal length of the entire zoom lens system becomes shorter and the amount of parallel movement necessary for blur correction is reduced. Therefore, at any of the zoom positions, for blur correction angles up to 0.3 degrees, sufficient blur correction is possible without causing imaging properties to drop. Further, the blur correction angle can be increased to be greater than 0.3 degrees by applying the amount of parallel movement of the stabilizing group VC₁ at the telephoto end to the wide angle end and intermediate focus positions.

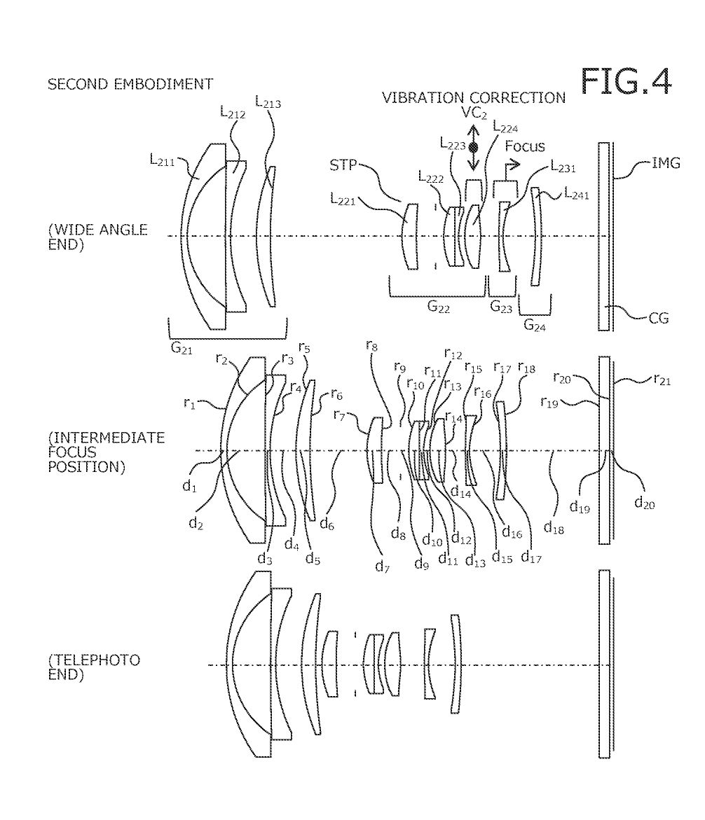

FIG. 4 is a diagram depicting, along the optical axis, a configuration of the zoom lens according to a second embodiment. The zoom lens includes sequentially from the object side nearest a non-depicted object, a first lens group G₂₁ having a negative refractive power, a second lens group G₂₂ having a positive refractive power, a third lens group G₂₃ having a negative refractive power, and a fourth lens group G₂₄ having a negative refractive power. The cover glass CG is disposed between the fourth lens group G₂₄ and the image plane IMG.

The first lens group G₂₁ includes sequentially from the object side, a negative lens L₂₁₁, a negative lens L₂₁₂, and a positive lens L₂₁₃.

The second lens group G₂₂ includes sequentially from the object side, a positive lens L₂₂₁, the aperture stop STP prescribing a given aperture, a positive lens L₂₂₂, a negative lens L₂₂₃, and a positive lens L₂₂₄ Both surfaces of the positive lens L₂₂₁ and of the positive lens L₂₂₄ are aspheric. The positive lens L₂₂₂ and the negative lens L₂₂₃ are cemented.

The third lens group G₂₃ is configured by a negative lens L₂₃₁. Both surfaces of the negative lens L₂₃₁ are aspheric.

The fourth lens group G₂₄ is configured by a negative lens L₂₄₁.

In the zoom lens, the second lens group G₂₂, the third lens group G₂₃, and the fourth lens group G₂₄ are moved along the optical axis, from the image plane IMG side toward the object side during zooming from the wide angle end to the telephoto end. During zooming, the second lens group G₂₂ and the fourth lens group G₂₄ move along loci of the same shape such that the respective distances moved by the second lens group G₂₂ and the fourth lens group G₂₄ are equal. From the wide angle end to an intermediate focus position, the first lens group G₂₁ moves from the object side toward the image plane IMG side, along the optical axis; and from an intermediate focus position to the telephoto end, the first lens group G₂₁ moves along the optical axis, from the image plane IMG side toward the object side by a concave locus. The interval between the first lens group G₂₁ and the second lens group G₂₂ decreases during zooming from the wide angle end to the telephoto end.

In the zoom lens, focusing from a focused state at infinity to a focused state at the minimum object distance is performed by moving the third lens group G₂₃ along the optical axis, from the object side toward the image plane IMG side. Further, the positive lens L₂₂₄ in the second lens group G₂₂ functions as a stabilizing group VC₂ and blur is corrected by moving the stabilizing group VC₂ in a direction that is substantially orthogonal to the optical axis.

Here, values of various types of data related to the zoom lens according to the second embodiment are given.

F number=3.61 (wide angle end) to 5.00 (intermediate focus position) to 5.77 (telephoto end)
Focal length of entire zoom lens system=20.66 (fw: wide angle end) to 32.05 (intermediate focus position) to 48.52 (ft: telephoto end)
Half angle of view (ω)=47.76 (wide angle end) to 33.67 (intermediate focus position) to 23.18 (telephoto end)

(Lens data)

| | | | |
|---|---|---|---|
| r₁ = 38.434 | d₁ = 1.500 | nd₁ = 1.9004 | νd₁ = 37.37 |
| r₂ = 20.233 | d₂ = 9.296 | | |
| r₃ = 791.597 | d₃ = 1.200 | nd₂ = 1.9004 | νd₂ = 37.37 |
| r₄ = 37.437 | d₄ = 6.309 | | |
| r₅ = 43.248 | d₅ = 3.422 | nd₃ = 1.9229 | νd₃ = 20.88 |
| r₆ = 112.221 | d₆ = D(6) | | |
| | (variable) | | |
| r₇ = 18.906 | d₇ = 3.500 | nd₄ = 1.5533 | νd₄ = 71.68 |
| (aspheric) | | | |
| r₈ = 88.766 | d₈ = 4.653 | | |
| (aspheric) | | | |
| r₉ = ∞ | d₉ = 2.000 | | |
| (aperture stop) | | | |
| r₁₀ = 18.249 | d₁₀ = 2.630 | nd₅ = 1.5935 | νd₅ = 67.00 |
| r₁₁ = −6434.288 | d₁₁ = 1.000 | nd₆ = 1.7234 | νd₆ = 37.99 |
| r₁₂ = 15.253 | d₁₂ = 1.500 | | |
| r₁₃ = 17.15 | d₁₃ = 3.825 | nd₇ = 1.5533 | νd₇ = 71.68 |
| (aspheric) | | | |
| r₁₄ = −38.636 | d₁₄ = D(14) | | |
| (aspheric) | (variable) | | |
| r₁₅ = 76.161 | d₁₅ = 1.000 | nd₈ = 1.7680 | νd₈ = 49.24 |
| (aspheric) | | | |
| r₁₆ = 18.261 | d₁₆ = D(16) | | |
| (aspheric) | (variable) | | |
| r₁₇ = −63.984 | d₁₇ = 1.500 | nd₉ = 1.9004 | νd₉ = 37.37 |
| r₁₈ = −100.005 | d₁₈ = D(18) | | |
| | (variable) | | |
| r₁₉ = ∞ | d₁₉ = 2.500 | nd₁₀ = 1.5168 | νd₁₀ = 64.20 |
| r₂₀ = ∞ | d₂₀ = 1.000 | | |
| r₂₁ = ∞ | | | |
| (image plane) | | | |

Constant of the conic (k) and aspheric coefficients (A₄, A₆, A₈, A₁₀)
(Seventh order)
k = 0, A₄ = −1.4877 × 10⁻⁵, A₆ = −9.0040 × 10⁻⁸, A₈ = 1.1709 × 10⁻⁹,
A₁₀ = −1.8415 × 10⁻¹¹
(Eighth order)
k = 0, A₄ = −8.6257 × 10⁻⁶, A₆ = 6.0877 × 10⁻⁸, A₈ = −1.5220 × 10⁻⁹,
A₁₀ = 2.7296 × 10⁻¹²
(Thirteenth order)
k = 0, A₄ = −7.3059 × 10⁻⁶, A₆ = 3.3782 × 10⁻⁷, A₈ = 3.3424 × 10⁻⁹,
A₁₀ = 1.1271 × 10⁻¹⁰
(Fourteenth order)
k = 0, A₄ = 3.9431 × 10⁻⁵, A₆ = 5.3842 × 10⁻⁷, A₈ = −2.7906 × 10⁻⁹,
A₁₀ = 2.2195 × 10⁻¹⁰
(Fifteenth order)
k = 0, A₄ = −6.4384 × 10⁻⁵, A₆ = −2.0677 × 10⁻⁷, A₈ = 5.2600 × 10⁻⁹,
A₁₀ = −5.8817 × 10⁻¹¹
(Sixteenth order)
k = 0, A₄ = −4.7605 × 10⁻⁵, A₆ = −1.6574 × 10⁻⁷, A₈ = 1.8901 × 10⁻⁹,
A₁₀ = −1.5735 × 10⁻¹¹

(Zoom data)

| | | Intermediate | |
|---|---|---|---|
| | Wide angle end | focus position | Telephoto end |
| D(6) | 32.004 | 13.863 | 1.500 |
| D(14) | 4.475 | 4.820 | 5.814 |
| D(16) | 7.834 | 7.489 | 6.495 |
| D(18) | 14.000 | 22.562 | 33.578 |

(Values related to conditional expression (1))
β4T (lateral magnification of fourth lens group G₂₄ at telephoto end)=1.191
(Values related to conditional expression (2))
f4 (focal length of fourth lens group G₂₄)=−201.254

$$\frac{\vert f 4 \vert}{\sqrt{( fw \times f t )}} = 6.356$$

(Values related to conditional expression (3))
f3 (focal length of third lens group G₂₃)=−31.512

$$\frac{\vert f 3 \vert}{\sqrt{( fw \times f t )}} = 0.995$$

(Values related to conditional expression (4))
fv (focal length of stabilizing group VC₂)=22.004

$$\frac{fv}{\sqrt{( fw \times f t )}} \leq 0.695$$

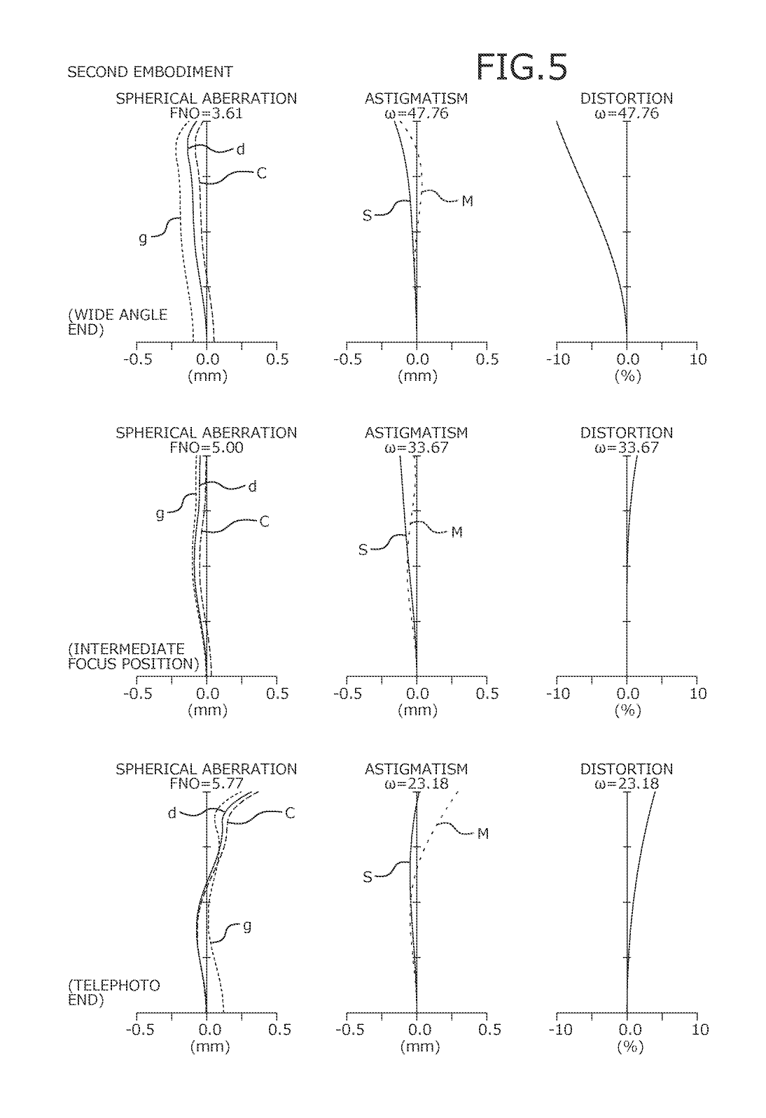

FIG. 5 is a diagram of various types of longitudinal aberration occurring in the zoom lens according to the second embodiment. In the diagram, for curves depicting spherical aberration, the vertical axis represents the F number (FNO), solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to the c-line (λ=656.28 nm). For curves depicting astigmatism, the vertical axis represents the half angle of view (ω), solid lines depict characteristics of the sagittal plane (S), and dashed lines depict characteristics of the meridional plane (M). For curves depicting distortion, the vertical axis represents the half angle of view (ω).

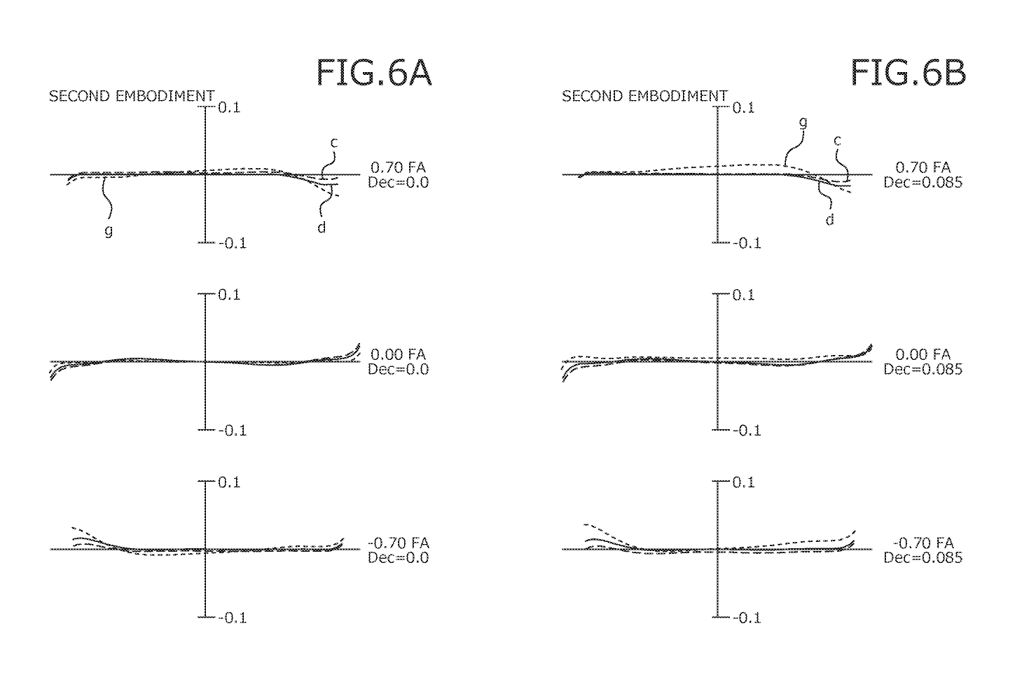

FIGS. 6A and 6B are diagrams of various types of transverse aberration occurring at the telephoto end of the zoom lens according to the second embodiment. FIG. 3A depicts a reference state where blur is not corrected at the telephoto end and FIG. 3B depicts a state where blur is corrected at the telephoto end, by moving the stabilizing group VC₂ 0.085 mm in a direction that is substantially orthogonal to the optical axis. Image displacement when the object distance is ∞ and the zoom lens is tilted 0.3 degrees at the telephoto end is equivalent to the image displacement when the stabilizing group VC₂ is moved 0.085 mm parallel to the direction that is substantially orthogonal to the optical axis.

In FIGS. 6A and 6B, an upper portion depicts transverse aberration at an image point corresponding to 70% of the maximum image height, a middle portion depicts transverse aberration at an image point on the optical axis, and a lower portion depicts transverse aberration at an image point corresponding to −70% of the maximum image height. In the figures, the horizontal axis represents the distance from the principal ray on the pupil plane, solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to the c-line (λ=656.28 nm).

From the figures depicting transverse aberration, it is clear that the symmetry of the transverse aberration at the image point on the axis is favorable. Further, comparison of the transverse aberration at the +70% image point and the transverse aberration at the −70% image point with the reference state reveals that for both, curvature is minimal and since the slopes of the aberration curves are substantially equivalent, eccentric comatic aberration and eccentric astigmatism are minimal, indicating that even in a state where blur is corrected, sufficient imaging performance can be obtained.

Further, when the blur correction angles of the zoom lens are the same, the focal length of the entire zoom lens system becomes shorter and the amount of parallel movement necessary for blur correction is reduced. Therefore, at any of the zoom positions, for blur correction angles up to 0.3 degrees, sufficient blur correction is possible without causing imaging properties to drop. Further, the blur correction angle can be increased to be greater than 0.3 degrees by applying the amount of parallel movement of the stabilizing group VC₂ at the telephoto end to the wide angle end and intermediate focus positions.

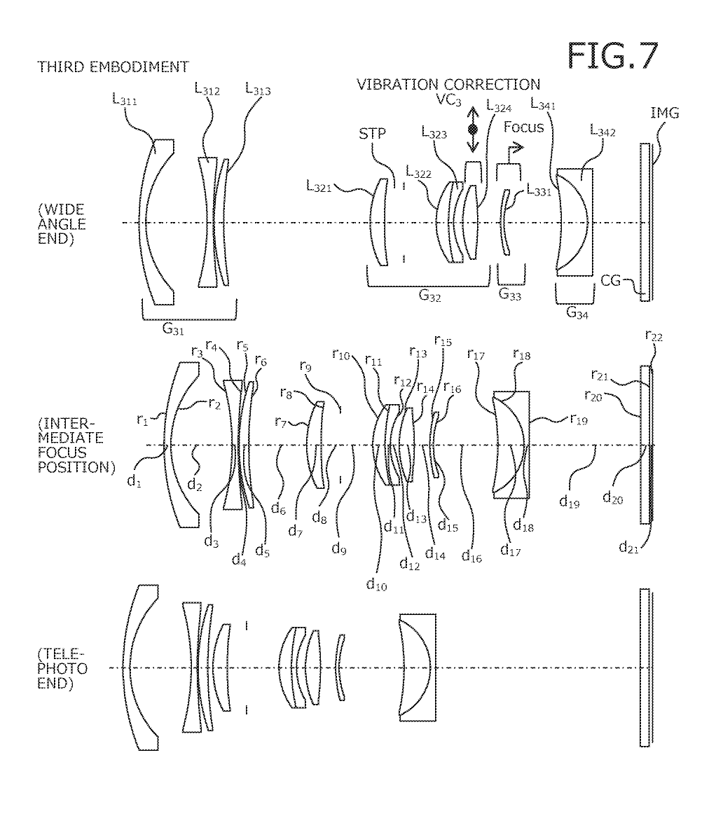

FIG. 7 is a diagram depicting, along the optical axis, a configuration of the zoom lens according to a third embodiment. The zoom lens includes sequentially from the object side nearest a non-depicted object, a first lens group G₃₁ having a negative refractive power, a second lens group G₃₂ having a positive refractive power, a third lens group G₃₃ having a negative refractive power, and a fourth lens group G₃₄ having a negative refractive power. The cover glass CG is disposed between the fourth lens group G₃₄ and the image plane IMG.

The first lens group G₃₁ includes sequentially from the object side, a negative lens L₃₁₁, a negative lens L₃₁₂, and a positive lens L₃₁₃.

The second lens group G₃₂ includes sequentially from the object side, a positive lens L₃₂₁, the aperture stop STP prescribing a given aperture, a positive lens L₃₂₂, a negative lens L₃₂₃, and a positive lens L₃₂₄. Both surfaces of the positive lens L₃₂₁ and of the positive lens L₃₂₄ are aspheric. The positive lens L₃₂₂ and the negative lens L₃₂₃ are cemented.

The third lens group G₃₃ is configured by a negative lens L₃₃₁. Both surfaces of the negative lens L₃₃₁ are aspheric.

The fourth lens group G₃₄ includes sequentially from the object side, a positive lens L₃₄₁ and a negative lens L₃₄₂. The positive lens L₃₄₁ and the negative lens L₃₄₂ are cemented.

In the zoom lens, the second lens group G₃₂, the third lens group G₃₃, and the fourth lens group G₃₄ are moved along the optical axis, from the image plane IMG side toward the object side during zooming from the wide angle end to the telephoto end. During zooming, the second lens group G₃₂ and the fourth lens group G₃₄ move along loci of the same shape such that the respective distances moved by the second lens group G₃₂ and the fourth lens group G₃₄ are equal. From the wide angle end to a vicinity of an intermediate focus position, the first lens group G₃₁ moves along the optical axis, from the object side toward the image plane IMG side; and from a vicinity of an intermediate focus position to the telephoto end, the first lens group G₃₁ moves along the optical axis, from the image plane IMG side toward the object side. The interval between the first lens group G₃₁ and the second lens group G₃₂ decreases during zooming from the wide angle end to the telephoto end.

In the zoom lens, focusing from a focused state at infinity to a focused state at the minimum object distance is performed by moving the third lens group G₃₃ along the optical axis, from the object side toward the image plane IMG side. Further, the positive lens L₃₂₄ in the second lens group G₃₂ functions as a stabilizing group VC₃ and blur is corrected by moving the stabilizing group VC₃ in a direction that is substantially orthogonal to the optical axis.

Here, values of various types of data related to the zoom lens according to the third embodiment are given.

F number=3.61 (wide angle end) to 5.00 (intermediate focus position) to 5.77 (telephoto end)
Focal length of entire zoom lens system=35.75 (fw: wide angle end) to 60.05 (intermediate focus position) to 97.03 (ft: telephoto end)
Half angle of view (ω)=32.12 (wide angle end) to 19.97 (intermediate focus position) to 12.57 (telephoto end)

(Lens data)

| | | | |
|---|---|---|---|
| r₁ = 63.037 | d₁ = 2.000 | nd₁ = 1.7440 | νd₁ = 44.90 |
| r₂ = 28.749 | d₂ = 17.902 | | |
| r₃ = −66.714 | d₃ = 1.800 | nd₂ = 1.4970 | νd₂ = 81.61 |
| r₄ = 140.415 | d₄ = 0.200 | | |
| r₅ = 56.268 | d₅ = 2.857 | nd₃ = 1.9212 | νd₃ = 23.96 |
| r₆ = 110.448 | d₆ = D(6) | | |
| | (variable) | | |
| r₇ = 28.369 | d₇ = 4.206 | nd₄ = 1.5533 | νd₄ = 71.68 |
| (aspheric) | | | |
| r₈ = 126.59 | d₈ = 5.643 | | |
| (aspheric) | | | |
| r₉ = ∞ | d₉ = 9.433 | | |
| (aperture stop) | | | |
| r₁₀ = 19.539 | d₁₀ = 3.617 | nd₅ = 1.4970 | νd₅ = 81.61 |
| r₁₁ = 49.491 | d₁₁ = 1.500 | nd₆ = 1.8061 | νd₆ = 33.27 |
| r₁₂ = 18.582 | d₁₂ = 2.643 | | |
| r₁₃ = 27.408 | d₁₃ = 4.350 | nd₇ = 1.4971 | νd₇ = 81.56 |
| (aspheric) | | | |
| r₁₄ = −61.095 | d₁₄ = D(14) | | |
| (aspheric) | (variable) | | |
| r₁₅ = 38.187 | d₁₅ = 1.000 | nd₈ = 1.4971 | νd₈ = 81.56 |
| (aspheric) | | | |
| r₁₆ = 25.234 | d₁₆ = D(16) | | |
| (aspheric) | (variable) | | |
| r₁₇ = −58.94 | d₁₇ = 7.681 | nd₉ = 1.8340 | νd₉ = 37.35 |
| r₁₈ = −15.16 | d₁₈ = 1.500 | nd₁₀ = 1.7440 | νd₁₀ = 44.90 |
| r₁₉ = ∞ | d₁₉ = D(19) | | |
| | (variable) | | |
| r₂₀ = ∞ | d₂₀ = 2.500 | nd₁₁ = 1.5168 | νd₁₁ = 64.20 |
| r₂₁ = ∞ | d₂₁ = 1.000 | | |
| r₂₂ = ∞ | | | |
| (image plane) | | | |

Constant of the conic (k) and aspheric coefficients (A₄, A₆, A₈, A₁₀)
(Seventh order)
k = 0, A₄ = 4.5021 × 10⁻⁶, A₆ = 1.2261 × 10⁻⁹, A₈ = 4.8619 × 10⁻¹¹,
A₁₀ = −1.6001 × 10⁻¹³
(Eighth order)
k = 0, A₄ = 1.0753 × 10 ⁻⁵, A₆ = −1.2030 × 10⁻¹⁰, A₈ = 3.0291 × 10⁻¹¹,
A₁₀ = −1.5518 × 10⁻¹³
(Thirteenth order)
k = 0, A₄ = 8.0338 × 10⁻⁶, A₆ = 1.5068 × 10⁻⁸, A₈ = 1.7215 × 10⁻¹⁰,
A₁₀ = − 1.6320 × 10⁻¹²
(Fourteenth order)
k = 0, A₄ = 1.6814 × 10⁻⁵, A₆ = 4.3003 × 10⁻⁸, A₈ = −1.1703 × 10⁻¹¹,
A₁₀ = −8.3841 × 10⁻¹³
(Fifteenth order)
k = 0, A₄ = 1.0654 × 10⁻⁶, A₆ = 1.4797 × 10⁻⁷, A₈ = −2.5956 × 10⁻¹¹,
A₁₀ = − 9.8068 × 10⁻¹³
(Sixteenth order)
k = 0, A₄ = 3.6518 × 10⁻⁶, A₆ = 1.3324 × 10⁻⁷, A₈ = 6.0483 × 10⁻¹⁰,
A₁₀ = −3.3732 × 10⁻¹²

(Zoom data)

| | | Intermediate | |
|---|---|---|---|
| | Wide angle end | focus position | Telephoto end |
| D(6) | 42.738 | 16.920 | 1.500 |
| D(14) | 6.724 | 4.615 | 4.474 |
| D(16) | 16.696 | 18.805 | 18.945 |
| D(19) | 14.000 | 32.565 | 59.850 |

(Values related to conditional expression (1))
β4T (lateral magnification of fourth lens group G₃₄ at telephoto end)=1.555
(Values related to conditional expression (2))
f4 (focal length of fourth lens group G₃₄)=−127.801

$$\frac{\vert f 4 \vert}{\sqrt{( fw \times f t )}} = 2.170$$

(Values related to conditional expression (3))
f3 (focal length of third lens group G₃₃)=−153.590

$$\frac{\vert f 3 \vert}{\sqrt{( fw \times f t )}} = 2.608$$

(Values related to conditional expression (4))
fv (focal length of stabilizing group VC₃)=38.693

$$\frac{fv}{\sqrt{( fw \times f t )}} \leq 0.657$$

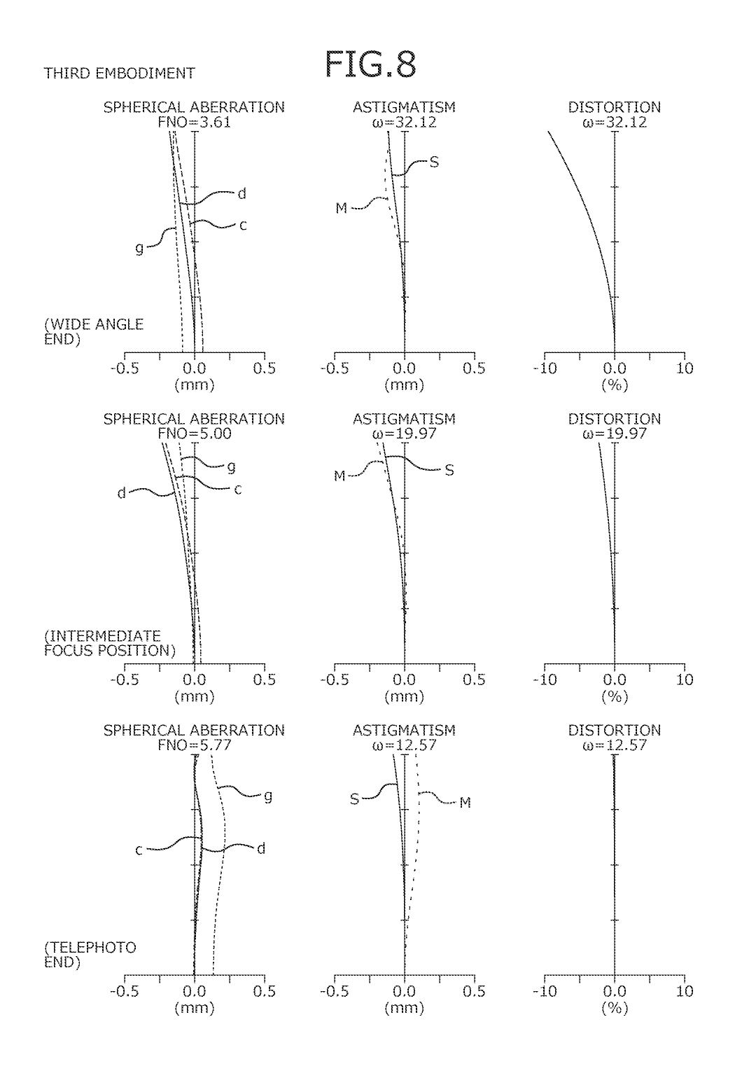

FIG. 8 is a diagram of various types of longitudinal aberration occurring in the zoom lens according to the third embodiment. In the diagram, for curves depicting spherical aberration, the vertical axis represents the F number (FNO), solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to the c-line (λ=656.28 nm). For curves depicting astigmatism, the vertical axis represents the half angle of view (ω), solid lines depict characteristics of the sagittal plane (S), and dashed lines depict characteristics of the meridional plane (M). For curves depicting distortion, the vertical axis represents the half angle of view (ω).

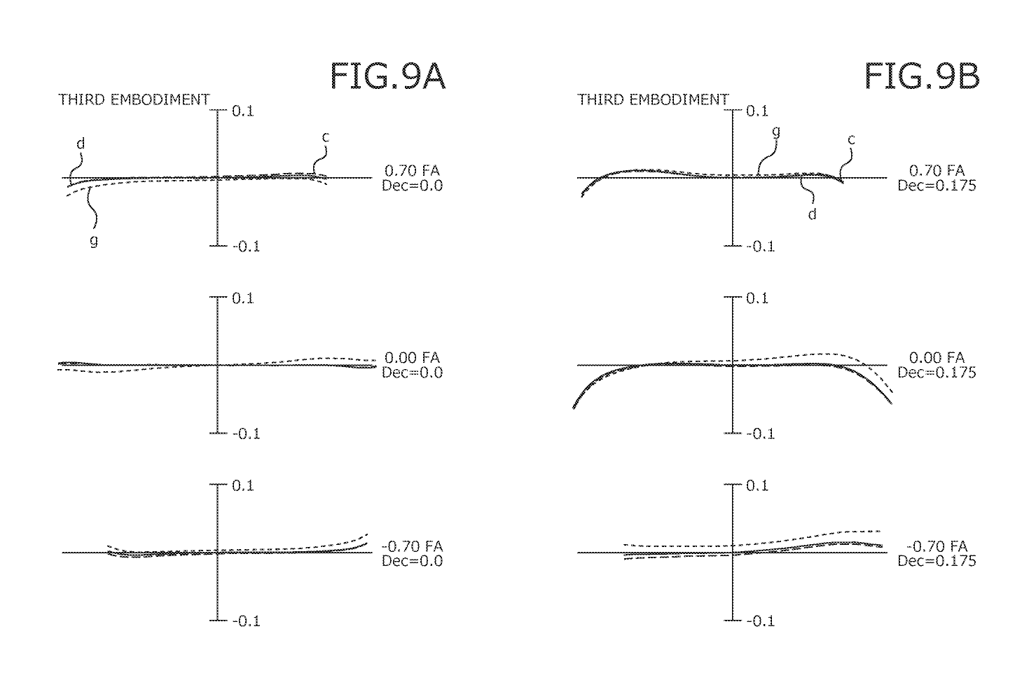

FIGS. 9A and 9B are diagrams of various types of transverse aberration occurring at the telephoto end of the zoom lens according to the third embodiment. FIG. 9A depicts a reference state where blur is not corrected at the telephoto end and FIG. 9B depicts a state where blur is corrected at the telephoto end, by moving the stabilizing group VC₃ 0.175 mm in a direction that is substantially orthogonal to the optical axis. Image displacement when the object distance is c and the zoom lens is tilted 0.3 degrees at the telephoto end is equivalent to the image displacement when the stabilizing group VC₃ is moved 0.175 mm parallel to the direction that is substantially orthogonal to the optical axis.

In FIGS. 9A and 9B, an upper portion depicts transverse aberration at an image point corresponding to 70% of the maximum image height, a middle portion depicts transverse aberration at an image point on the optical axis, and a lower portion depicts transverse aberration at an image point corresponding to −70% of the maximum image height. In the figures, the horizontal axis represents the distance from the principal ray on the pupil plane, solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to the c-line (λ=656.28 nm).

From the figures depicting transverse aberration, it is clear that the symmetry of the transverse aberration at the image point on the optical axis is favorable. Further, comparison of the transverse aberration at the +70% image point and the transverse aberration at the −70% image point with the reference state reveals that for both, curvature is minimal and since the slopes of the aberration curves are substantially equivalent, eccentric comatic aberration and eccentric astigmatism are minimal, indicating that even in a state where blur is corrected, sufficient imaging performance can be obtained.

Further, when the blur correction angles of the zoom lens are the same, the focal length of the entire zoom lens system becomes shorter and the amount of parallel movement necessary for blur correction is reduced. Therefore, at any of the zoom positions, for blur correction angles up to 0.3 degrees, sufficient blur correction is possible without causing imaging properties to drop. Further, the blur correction angle can be increased to be greater than 0.3 degrees by applying the amount of parallel movement of the stabilizing group VC₃ at the telephoto end to the wide angle end and intermediate focus positions.

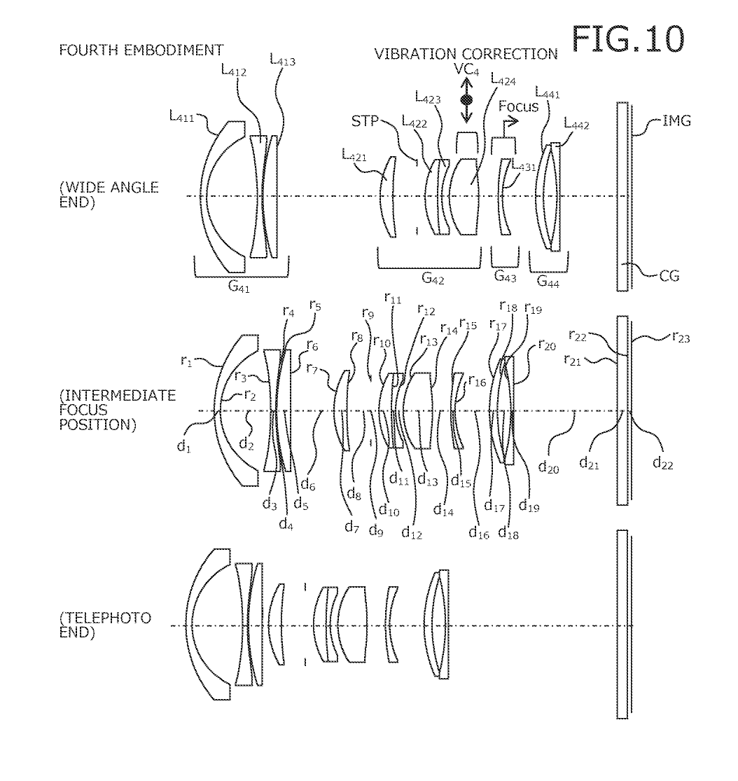

FIG. 10 is a diagram depicting, along the optical axis, a configuration of the zoom lens according to a fourth embodiment. The zoom lens includes sequentially from the object side nearest a non-depicted object, a first lens group G₄₁ having a negative refractive power, a second lens group G₄₂ having a positive refractive power, a third lens group G₄₃ having a negative refractive power, and a fourth lens group G₄₄ having a negative refractive power. The cover glass CG is disposed between the fourth lens group G₄₄ and the image plane IMG.

The first lens group G₄₁ includes sequentially from the object side, a negative lens L₄₁₁, a negative lens L₄₁₂, and a positive lens L₄₁₃. Both surfaces of the negative lens L₄₁₂ are aspheric.

The second lens group G₄₂ includes sequentially from the object side, a positive lens L₄₂₁, the aperture stop STP prescribing a given aperture, a positive lens L₄₂₂, a negative lens L₄₂₃, and a positive lens L₄₂₄. Both surfaces of the positive lens L₄₂₁ and of the positive lens L₄₂₄ are aspheric. The positive lens L₄₂₂ and the negative lens L₄₂₃ are cemented.

The third lens group G₄₃ is configured by a negative lens L₄₃₁. Both surfaces of the negative lens L₄₃₁ are aspheric.

The fourth lens group G₄₄ includes sequentially from the object side, a positive lens L₄₄₁ and a negative lens L₄₄₂.

In the zoom lens, the second lens group G₄₂, the third lens group G₄₃, and the fourth lens group G₄₄ are moved along the optical axis, from the image plane IMG side toward the object side during zooming from the wide angle end to the telephoto end. During zooming, the second lens group G₄₂ and the fourth lens group G₄₄ move along loci of the same shape such that the respective distances moved by the second lens group G₄₂ and the fourth lens group G₄₄ are equal. From the wide angle end to a vicinity of an intermediate focus position, the first lens group G₄₁ moves along the optical axis, from the object side toward the image plane IMG side; and from a vicinity of an intermediate focus position to the telephoto end, the first lens group G₄₁ moves along the optical axis, from the image plane IMG side toward the object side. The interval between the first lens group G₄₁ and the second lens group G₄₂ decreases during zooming from the wide angle end to the telephoto end.

In the zoom lens, focusing from a focused state at infinity to a focused state at the minimum object distance is performed by moving the third lens group G₄₃ along the optical axis, from the object side toward the image plane IMG side. Further, the positive lens L₄₂₄ in the second lens group G₄₂ functions as a stabilizing group VC₄ and blur is corrected by moving the stabilizing group VC₄ in a direction that is substantially orthogonal to the optical axis.

Here, values of various types of data related to the zoom lens according to the fourth embodiment are given.

F number=3.61 (wide angle end) to 5.00 (intermediate focus position) to 5.77 (telephoto end)
Focal length of entire zoom lens system=28.92 (fw: wide angle end) to 45.01 (intermediate focus position) to 67.86 (ft: telephoto end)
Half angle of view (ω)=37.39 (wide angle end) to 25.47 (intermediate focus position) to 17.37 (telephoto end)

(Lens data)

| | | | |
|---|---|---|---|
| r₁ = 27.458 | d₁ = 1.500 | nd₁= 2.0010 | νd₁ = 29.13 |
| r₂ = 15.935 | d₂ = 12.313 | | |
| r₃ = −69.93 | d₃ = 1.200 | nd₂ = 1.5533 | νd₂ = 71.68 |
| (aspheric) | | | |
| r₄ = 52.112 | d₄ = 0.200 | | |
| (aspheric) | | | |
| r₅ = 49.372 | d₅ = 3.428 | nd₃ = 1.9212 | νd₃ = 23.96 |
| r₆ = −4302.934 | d₆ = D(6) | | |
| | (variable) | | |
| r₇ = 19.014 | d₇ = 3.140 | nd₄ = 1.4971 | νd₄ = 81.56 |
| (aspheric) | | | |
| r₈ = 77.999 | d₈ = 5.807 | | |
| (aspheric) | | | |
| r₉ = ∞ | d₉ = 2.000 | | |
| (aperture stop) | | | |
| r₁₀ = 18.072 | d₁₀ = 3.047 | nd₅ = 1.4970 | νd₅ = 81.61 |
| r₁₁ = 79.019 | d₁₁ = 1.000 | nd₆ = 1.8340 | νd₆ = 37.35 |
| r₁₂ = 16.501 | d₁₂ = 1.887 | | |
| r₁₃ = 16.774 | d₁₃ = 7.114 | nd₇ = 1.4971 | νd₇ = 81.56 |
| (aspheric) | | | |
| r₁₄ = −40.945 | d₁₄ = D(14) | | |
| (aspheric) | (variable) | | |
| r₁₅ = 47.542 | d₁₅ = 1.000 | nd₈ = 1.4971 | νd₈ = 81.56 |
| (aspheric) | | | |
| r₁₆ = 20.402 | d₁₆ = D(16) | | |
| (aspheric) | (variable) | | |
| r₁₇ = 30.727 | d₁₇ = 1.922 | nd₉ = 1.9212 | νd₉ = 23.96 |
| r₁₈ = 37.231 | d₁₈ = 3.270 | | |
| r₁₉ = −46.985 | d₁₉ = 0.700 | nd₁₀ = 1.9108 | νd₁₀ = 35.25 |
| r₂₀ = ∞ | d₂₀ = D(20) | | |
| | (variable) | | |
| r₂₁ = ∞ | d₂₁ = 2.500 | nd₁₁ = 1.5168 | νd₁₁ = 64.20 |
| r₂₂ = ∞ | d₂₂ = 1.000 | | |
| r₂₃ = ∞ | | | |
| (image plane) | | | |

Constant of the conic (k) and aspheric coefficients (A₄, A₆, A₈, A₁₀)
(Third order)
k = 0, A₄ = −4.4866 × 10⁻⁶, A₆ = −1.2022 × 10⁻⁸, A₈ = 1.8532 × 10⁻¹⁰,
A₁₀ = −7.1817 × 10⁻¹³
(Fourth order)
k = 0, A₄ = −1.5113 × 10⁻⁵, A₆ = − 3.1196 × 10⁻⁸, A₈ = 1.9463 × 10⁻¹⁰,
A₁₀ = −9.4189 × 10⁻¹³
(Seventh order)
k = 0, A₄ = −1.8429 × 10⁻⁶, A₆ = −2.3953 × 10⁻⁸, A₈ = 1.0234 × 10⁻⁹,
A₁₀ = −1.0415 × 10⁻¹¹
(Eighth order)
k = 0, A₄ = 9.4860 × 10⁻⁶, A₆ = 1.0504 × 10⁻⁸, A₈ = 9.0970 × 10⁻¹⁰,
A₁₀ = −1.1496 × 10⁻¹¹
(Thirteenth order)
k = 0, A₄ = −3.9022 × 10⁻⁶, A₆ = 1.5090 × 10⁻⁷, A₈ = 7.1601 × 10⁻¹⁰,
A₁₀ = 1.9246 × 10⁻¹²
(Fourteenth order)
k = 0, A₄ = 4.0691 × 10⁻⁵, A₆ = 2.7179 × 10⁻⁷, A₈ = 1.2901 × 10⁻⁹,
A₁₀ = 6.3945 × 10⁻¹²
(Fifteenth order)
k = 0, A₄ = −2.1875 × 10⁻⁵, A₆ = 1.4786 × 10⁻⁷, A₈ = 2.7708 × 10⁻⁹,
A₁₀ = −2.5817 × 10⁻¹¹
(Sixteenth order)
k = 0, A₄ = −1.6529 × 10⁻⁵, A₆ = 9.5712 × 10⁻⁸, A₈ = 2.5183 × 10⁻⁹,
A₁₀ = −1.7952 × 10⁻¹¹

(Zoom data)

| | | Intermediate | |
|---|---|---|---|
| | Wide angle end | focus position | Telephoto end |
| D(6) | 25.108 | 10.537 | 1.500 |
| D(14) | 4.767 | 4.498 | 4.501 |
| D(16) | 8.097 | 8.365 | 8.362 |
| D(20) | 14.000 | 25.253 | 41.118 |

(Values related to conditional expression (1))
β4T (lateral magnification of fourth lens group G₄₄ at telephoto end)=1.498
(Values related to conditional expression (2))
f4 (focal length of fourth lens group G₄₄)=−80.349

$$\frac{\vert f 4 \vert}{\sqrt{( fw \times f t )}} = 1.814$$

(Values related to conditional expression (3))
f3 (focal length of third lens group G₄₃)=−72.784

$$\frac{\vert f 3 \vert}{\sqrt{( fw \times f t )}} = 1.643$$

(Values related to conditional expression (4))
fv (focal length of stabilizing group VC₄)=24.958

$$\frac{fv}{\sqrt{( fw \times f t )}} = 0.563$$

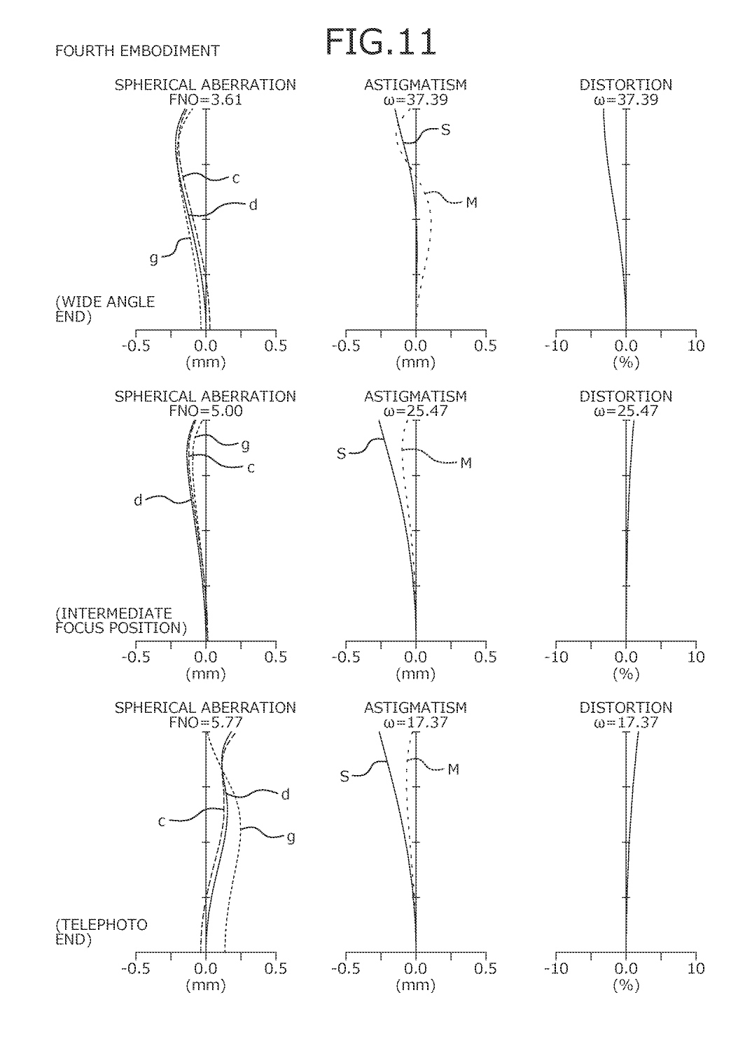

FIG. 11 is a diagram of various types of longitudinal aberration occurring in the zoom lens according to the fourth embodiment. In the diagram, for curves depicting spherical aberration, the vertical axis represents the F number (FNO), solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to the c-line (λ=656.28 nm). For curves depicting astigmatism, the vertical axis represents the half angle of view (ω), solid lines depict characteristics of the sagittal plane (S), and dashed lines depict characteristics of the meridional plane (M). For curves depicting distortion, the vertical axis represents the half angle of view (ω).

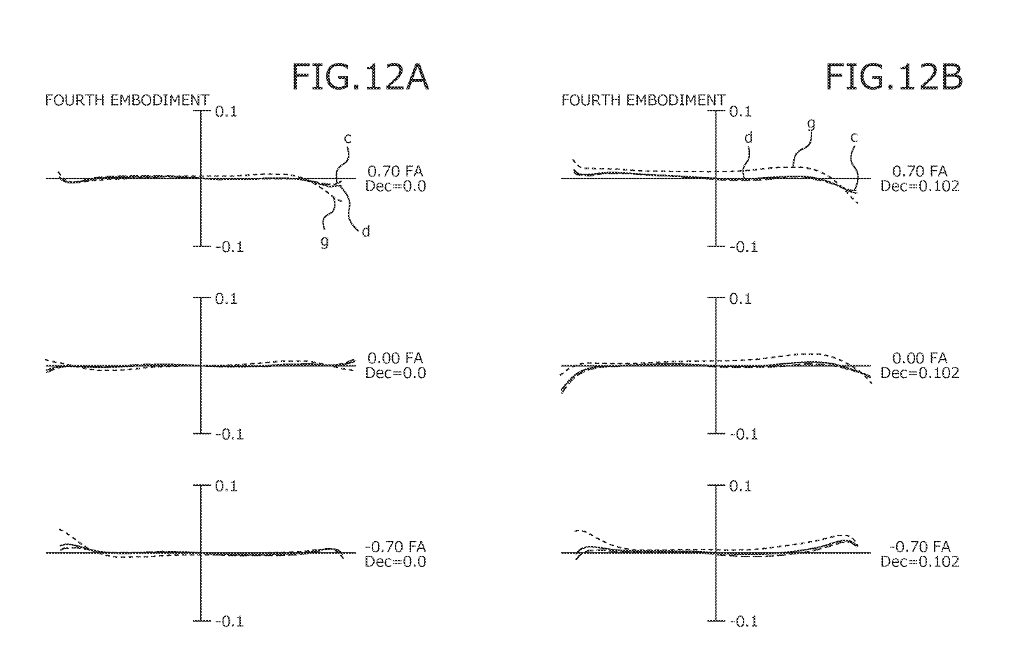

FIGS. 12A and 12B are diagrams of various types of transverse aberration occurring at the telephoto end of the zoom lens according to the fourth embodiment. FIG. 12A depicts a reference state where blur is not corrected at the telephoto end and FIG. 12B depicts a state where blur is corrected at the telephoto end, by moving the stabilizing group VC₄ 0.102 mm in a direction that is substantially orthogonal to the optical axis. Image displacement when the object distance is ∞ and the zoom lens is tilted 0.3 degrees at the telephoto end is equivalent to the image displacement when the stabilizing group VC₄ is moved 0.102 mm parallel to the direction that is substantially orthogonal to the optical axis.

In FIGS. 12A and 12B, an upper portion depicts transverse aberration at an image point corresponding to 70% of the maximum image height, a middle portion depicts transverse aberration at an image point on the optical axis, and a lower portion depicts transverse aberration at an image point corresponding to −70% of the maximum image height. In the figures, the horizontal axis represents the distance from the principal ray on the pupil plane, solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to the c-line (λ=656.28 nm).

From the figures depicting transverse aberration, it is clear that the symmetry of the transverse aberration at the image point on the optical axis is favorable. Further, comparison of the transverse aberration at the +70% image point and the transverse aberration at the −70% image point with the reference state reveals that for both, curvature is minimal and since the slopes of the aberration curves are substantially equivalent, eccentric comatic aberration and eccentric astigmatism are minimal, indicating that even in a state where blur is corrected, sufficient imaging performance can be obtained.

Further, when the blur correction angles of the zoom lens are the same, the focal length of the entire zoom lens system becomes shorter and the amount of parallel movement necessary for blur correction is reduced. Therefore, at any of the zoom positions, for blur correction angles up to 0.3 degrees, sufficient blur correction is possible without causing imaging properties to drop. Further, the blur correction angle can be increased to be greater than 0.3 degrees by applying the amount of parallel movement of the stabilizing group VC₄ at the telephoto end to the wide angle end and intermediate focus positions.

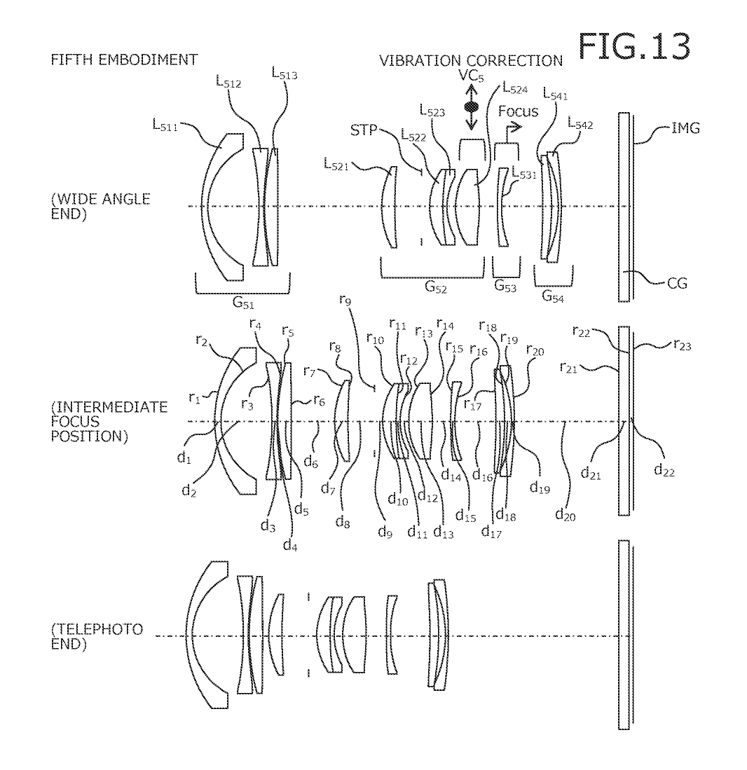

FIG. 13 is a diagram depicting, along the optical axis, a configuration of the zoom lens according to a fifth embodiment. The zoom lens includes sequentially from the object side nearest a non-depicted object, a first lens group G₅₁ having a negative refractive power, a second lens group G₅₂ having a positive refractive power, a third lens group G₅₃ having a negative refractive power, and a fourth lens group G₅₄ having a negative refractive power. The cover glass CG is disposed between the fourth lens group G₅₄ and the image plane IMG.

The first lens group G₅₁ includes sequentially from the object side, a negative lens L₅₁₁, a negative lens L₅₁₂ and a positive lens L₅₁₃. Both surfaces of the negative lens L₅₁₂ are aspheric.

The second lens group G₅₂ includes sequentially from the object side, a positive lens L₅₂₁, the aperture stop STP prescribing a given aperture, a positive lens L₅₂₂, a negative lens L₅₂₃, and a positive lens L₅₂₄. Both surfaces of the positive lens L₅₂₁ and of the positive lens L₅₂₄ are aspheric. The positive lens L₅₂₂ and the negative lens L₅₂₃ are cemented.

The third lens group G₅₃ is configured by a negative lens L₅₃₁. Both surfaces of the negative lens L₅₃₁ are aspheric.

The fourth lens group G₅₄ includes sequentially from the object side, a positive lens L₅₄₁ and a negative lens L₅₄₂.

In the zoom lens, the second lens group G₅₂, the third lens group G₅₃, and the fourth lens group G₅₄ are moved along the optical axis, from the image plane IMG side toward the object side during zooming from the wide angle end to the telephoto end. During zooming, the second lens group G₅₂ and the fourth lens group G₅₄ move along loci of the same shape such that the respective distances moved by the second lens group G₅₂ and the fourth lens group G₅₄ are equal. From the wide angle end to a vicinity of an intermediate focus position, the first lens group G₅₁ moves along the optical axis, from the object side toward the image plane IMG side; and from a vicinity of an intermediate focus position to the telephoto end, the first lens group G₅₁ moves along the optical axis, from the image plane IMG side toward the object side. The interval between the first lens group G₅₁ and the second lens group G₅₂ decreases during zooming from the wide angle end to the telephoto end.

In the zoom lens, focusing from a focused state at infinity to a focused state at the minimum object distance is performed by moving the third lens group G₅₃ along the optical axis, from the object side toward the image plane IMG side. Further, the positive lens L₅₂₄ in the second lens group G₅₂ functions as a stabilizing group VC₅ and blur is corrected by moving the stabilizing group VC₅ in a direction that is substantially orthogonal to the optical axis.

Here, values of various types of data related to the zoom lens according to the fifth embodiment are given. F number=3.61 (wide angle end) to 5.00 (intermediate focus position) to 5.77 (telephoto end)

Focal length of entire zoom lens system=28.92 (fw: wide angle end) to 45.02 (intermediate focus position) to 67.85 (ft: telephoto end)
Half angle of view (ω)=37.39 (wide angle end) to 25.42 (intermediate focus position) to 17.37 (telephoto end)

(Lens data)

| | | | |
|---|---|---|---|
| r₁ = 28.241 | d₁ = 1.500 | nd₁ = 2.0010 | νd₁= 29.13 |
| r₂ = 15.829 | d₂ = 12.427 | | |
| r₃ = −71.026 | d₃ = 1.200 | nd₂ = 1.5533 | νd₂ = 71.68 |
| (aspheric) | | | |
| r₄ = 55.262 | d₄ = 0.204 | | |
| (aspheric) | | | |
| r₅ = 52.655 | d₅ = 3.275 | nd₃ = 1.9212 | νd₃ = 23.96 |
| r₆ = −785.575 | d₆ = D(6) | | |
| | (variable) | | |
| r₇ = 20.473 | d₇ = 3.227 | nd₄ = 1.4971 | νd₄ = 81.56 |
| (aspheric) | | | |
| r₈ = 148.942 | d₈ = 6.445 | | |
| (aspheric) | | | |
| r₉ = ∞ | d₉ = 2.000 | | |
| (aperture stop) | | | |
| r₁₀ = 15.753 | d₁₀ = 3.231 | nd₅ = 1.4970 | νd₅ = 81.61 |
| r₁₁ = 54.031 | d₁₁ = 1.000 | nd₆ = 1.8340 | νd₆ = 37.35 |
| r₁₂ = 14.926 | d₁₂ = 2.092 | | |
| r₁₃ = 17.356 | d₁₃ = 5.733 | nd₇ = 1.4971 | νd₇ = 81.56 |
| (aspheric) | | | |
| r₁₄ = −44.700 | d₁₄ = D(14) | | |
| (aspheric) | (variable) | | |
| r₁₅ = 110.200 | d₁₅ = 1.000 | nd₈ = 1.4971 | νd₈ = 81.56 |
| (aspheric) | | | |
| r₁₆ = 28.598 | d₁₆ = D(16) | | |
| (aspheric) | (variable) | | |
| r₁₇ = −177.755 | d₁₇ = 2.130 | nd₉ = 1.9212 | νd₉ = 23.96 |
| r₁₈ = −67.446 | d₁₈ = 1.664 | | |
| r₁₉ = −27.598 | d₁₉ = 0.700 | nd₁₀ = 1.9108 | νd₁₀ = 35.25 |
| r₂₀ = −91.579 | d₂₀ = D(20) | | |
| | (variable) | | |
| r₂₁ = ∞ | d₂₁ = 2.500 | nd₁₁ = 1.5168 | νd₁₁ = 64.20 |
| r₂₂ = ∞ | d₂₂ = 1.000 | | |
| r₂₃ = ∞ | | | |
| (image plane) | | | |

Constant of the conic (k) and aspheric coefficients (A₄, A₆, A₈, A₁₀)
(Third order)
k = 0, A₄ = −2.6568 × 10⁻⁶, A₆ = −1.4569 × 10⁻⁸, A₈ = 1.7331 × 10⁻¹⁰,
A₁₀ = −6.6514 × 10⁻¹³
(Fourth order)
k = 0, A₄ = −1.4063 × 10⁻⁵, A₆ = −3.5564 × 10⁻⁸, A₈ = 1.8827 × 10⁻¹⁰,
A₁₀ = −9.4772 × 10⁻¹³
(Seventh order)
k = 0, A₄ = −3.3216 × 10⁻⁶, A₆ = −2.6151 × 10⁻⁸, A₈ = 8.7065 × 10⁻¹⁰,
A₁₀ = −6.1380 × 10⁻¹²
(Eighth order)
k = 0, A₄ = 6.4478 × 10⁻⁶, A₆ = −2.8624 × 10⁻⁹, A₈ = 8.9076 × 10⁻¹⁰,
A₁₀ = −7.2385 × 10⁻¹²
(Thirteenth order)
k = 0, A₄ = 5.8905 × 10⁻⁸, A₆ = 1.7413 × 10⁻⁷, A₈ = 1.1560 × 10⁻⁹,
A₁₀ = 9.2689 × 10⁻¹²
(Fourteenth order)
k = 0, A₄ = 3 .4893 × 10⁻⁵, A₆ = 3.1544 × 10⁻⁷, A₈ = 1.3099 × 10⁻⁹,
A₁₀ = 1.7124 × 10⁻¹¹
(Fifteenth order)
k = 0, A₄ = −1.7912 × 10⁻⁵, A₆ = 2.7654 × 10⁻⁷, A₈ = 4.3738 × 10⁻⁹,
A₁₀ = −4.1598 × 10⁻¹¹
(Sixteenth order)
k = 0, A₄ = −8.6549 × 10⁻⁶, A₆ = 2.4706 × 10⁻⁷, A₈ = 2.9936 × 10⁻⁹,
A₁₀ = −2.3373 × 10⁻¹¹

(Zoom data)

| | | Intermediate | |
|---|---|---|---|
| | Wide angle end | focus position | Telephoto end |
| D(6) | 25.210 | 10.597 | 1.500 |
| D(14) | 4.447 | 4.497 | 4.857 |
| D(16) | 10.013 | 9.962 | 9.603 |
| D(20) | 14.000 | 25.440 | 41.435 |

(Values related to conditional expression (1))
β4T (lateral magnification of fourth lens group G₅₄ at telephoto end)=1.625
(Values related to conditional expression (2))
f4 (focal length of fourth lens group G₅₄)=−70.328

$$\frac{\vert f 4 \vert}{\sqrt{( fw \times f t )}} = 1.588$$

(Values related to conditional expression (3))
f3 (focal length of third lens group G₅₃)=−78.007

$$\frac{\vert f 3 \vert}{\sqrt{( fw \times f t )}} = 1.761$$

(Values related to conditional expression (4))
fv (focal length of stabilizing group VC₅)=25.945

$$\frac{fv}{\sqrt{( fw \times f t )}} = 0.586$$

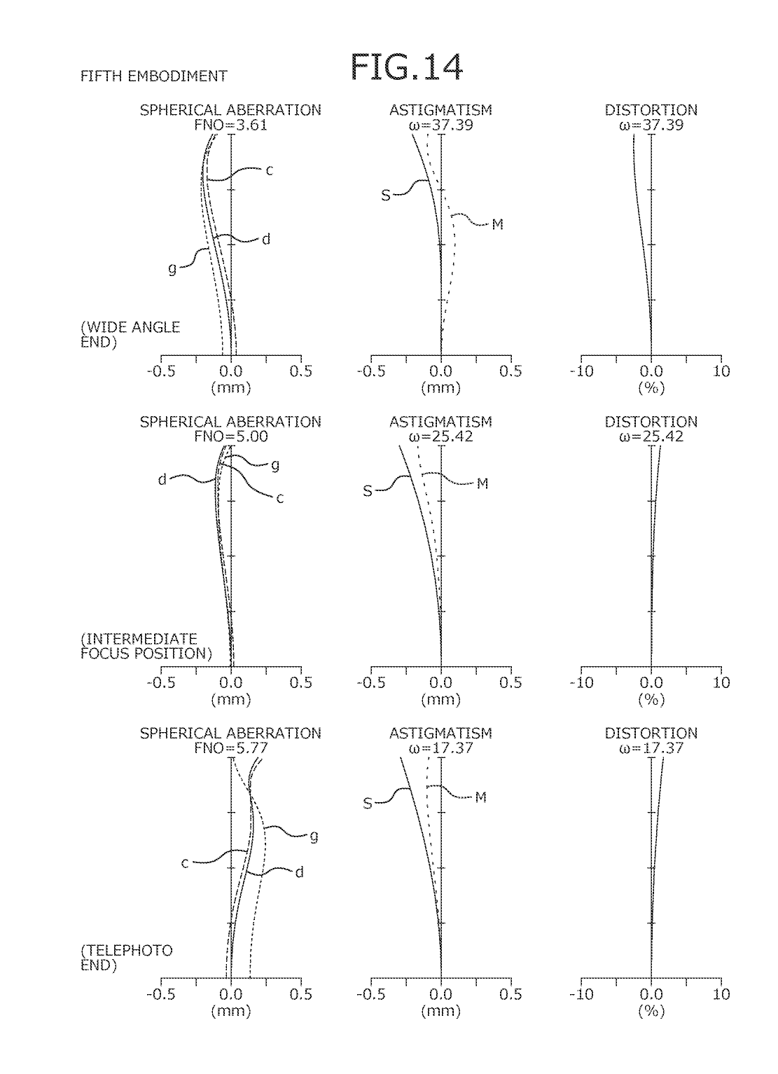

FIG. 14 is a diagram of various types of longitudinal aberration occurring in the zoom lens according to the fifth embodiment. In the diagram, for curves depicting spherical aberration, the vertical axis represents the F number (FNO), solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to the c-line (λ=656.28 nm). For curves depicting astigmatism, the vertical axis represents the half angle of view (ω), solid lines depict characteristics of the sagittal plane (S), and dashed lines depict characteristics of the meridional plane (M). For curves depicting distortion, the vertical axis represents the half angle of view (ω).

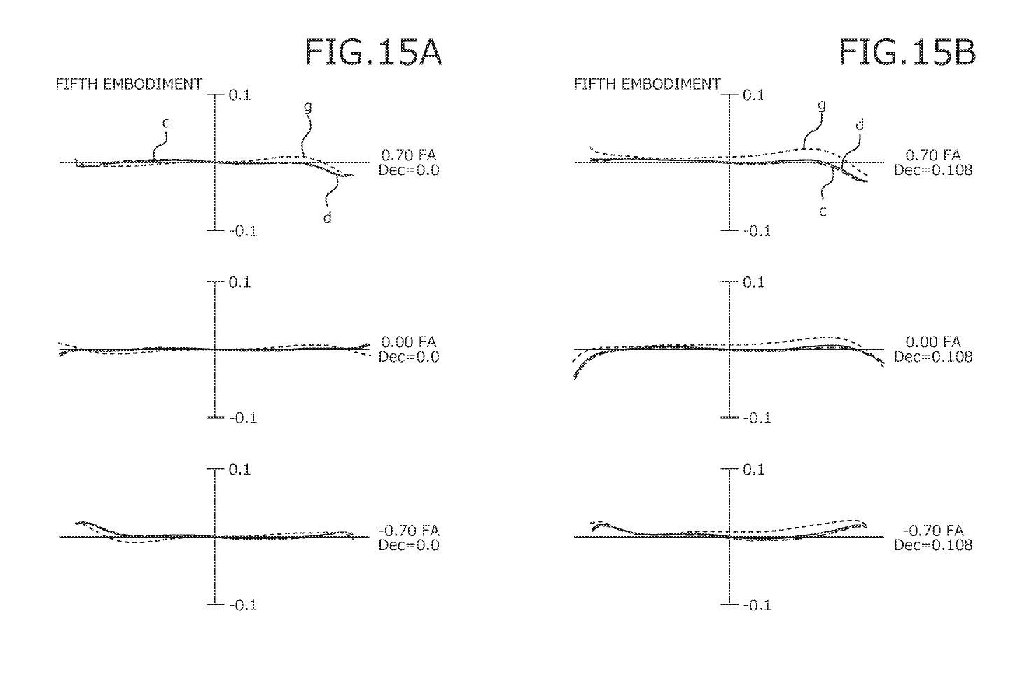

FIGS. 15A and 15B are diagrams of various types of transverse aberration occurring at the telephoto end of the zoom lens according to the fifth embodiment. FIG. 15A depicts a reference state where blur is not corrected at the telephoto end and FIG. 15B depicts a state where blur is corrected at the telephoto end, by moving the stabilizing group VC₅ 0.108 mm in a direction that is substantially orthogonal to the optical axis. Image displacement when the object distance is ∞ and the zoom lens is tilted 0.3 degrees at the telephoto end is equivalent to the image displacement when the stabilizing group VC₅ is moved 0.108 mm parallel to the direction that is substantially orthogonal to the optical axis.

In FIGS. 15A and 15B, an upper portion depicts transverse aberration at an image point corresponding to 70% of the maximum image height, a middle portion depicts transverse aberration at an image point on the optical axis, and a lower portion depicts transverse aberration at an image point corresponding to −70% of the maximum image height. In the figures, the horizontal axis represents the distance from the principal ray on the pupil plane, solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to the c-line (λ=656.28 nm).

From the figures depicting transverse aberration, it is clear that the symmetry of the transverse aberration at the image point on the optical axis is favorable. Further, comparison of the transverse aberration at the +70% image point and the transverse aberration at the −70% image point with the reference state reveals that for both, curvature is minimal and since the slopes of the aberration curves are substantially equivalent, eccentric comatic aberration and eccentric astigmatism are minimal, indicating that even in a state where blur is corrected, sufficient imaging performance can be obtained.

Further, when the blur correction angles of the zoom lens are the same, the focal length of the entire zoom lens system becomes shorter and the amount of parallel movement necessary for blur correction is reduced. Therefore, at any of the zoom positions, for blur correction angles up to 0.3 degrees, sufficient blur correction is possible without causing imaging properties to drop. Further, the blur correction angle can be increased to be greater than 0.3 degrees by applying the amount of parallel movement of the stabilizing group VC₅ at the telephoto end to the wide angle end and intermediate focus positions.

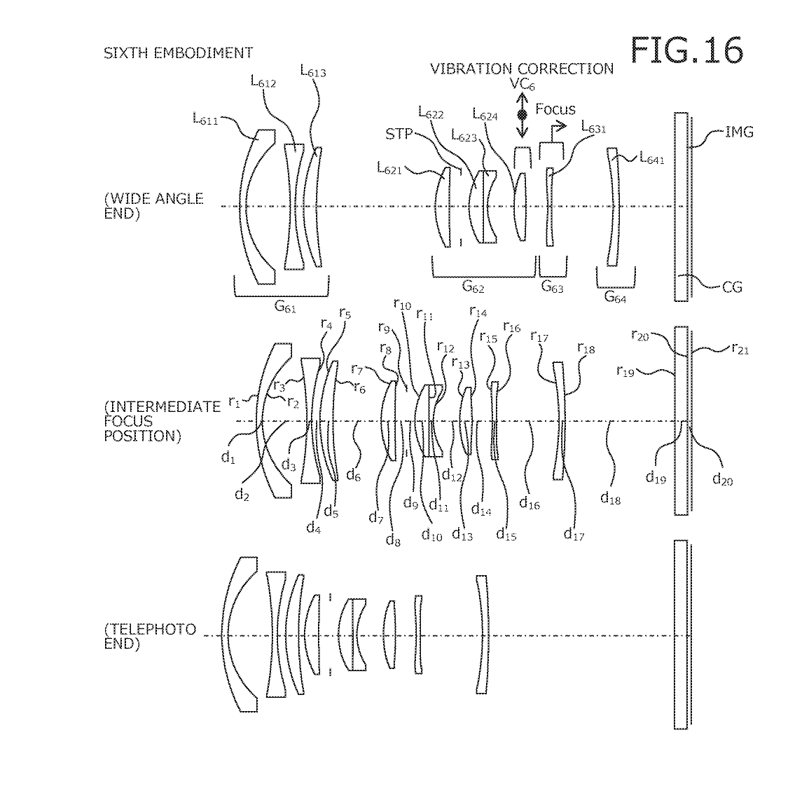

FIG. 16 is a diagram depicting, along the optical axis, a configuration of the zoom lens according to a sixth embodiment. The zoom lens includes sequentially from the object side nearest a non-depicted object, a first lens group G₆₁ having a negative refractive power, a second lens group G₆₂ having a positive refractive power, a third lens group G₆₃ having a negative refractive power, and a fourth lens group G₆₄ having a negative refractive power. The cover glass CG is disposed between the fourth lens group G₆₄ and the image plane IMG.

The first lens group G₆₁ includes sequentially from the object side, a negative lens L₆₁₁, a negative lens L₆₁₂, and a positive lens L₆₁₃.

The second lens group G₆₂ includes sequentially from the object side, a positive lens L₆₂₁, the aperture stop STP prescribing a given aperture, a positive lens L₆₂₂, a negative lens L₆₂₃, and a positive lens L₆₂₄. Both surfaces of the positive lens L₆₂₁ and of the positive lens L₆₂₄ are aspheric. The positive lens L₆₂₂ and the negative lens L₆₂₃ are cemented.

The third lens group G₆₃ is configured by a negative lens L₆₃₁. Both surfaces of the negative lens L₆₃₁ are aspheric.

The fourth lens group G₆₄ is configured by a negative lens L₆₄₁.

In the zoom lens, the second lens group G₆₂, the third lens group G₆₃, and the fourth lens group G₆₄ are moved along the optical axis, from the image plane IMG side toward the object side during zooming from the wide angle end to the telephoto end. During zooming, the second lens group G₆₂ and the fourth lens group G₆₄ move along loci of the same shape such that the respective distances moved by the second lens group G₆₂ and the fourth lens group G₆₄ are equal. From the wide angle end to a vicinity of an intermediate focus position, the first lens group G₆₁ moves along the optical axis, from the object side toward the image plane IMG side; and from a vicinity of an intermediate focus position to the telephoto end, the first lens group G₆₁ moves along the optical axis, from the image plane IMG side toward the object side. The interval between the first lens group G₆₁ and the second lens group G₆₂ decreases during zooming from the wide angle end to the telephoto end.

In the zoom lens, focusing from a focused state at infinity to a focused state at the minimum object distance is performed by moving the third lens group G₆₃ along the optical axis, from the object side toward the image plane IMG side. Further, the positive lens L₆₂₄ in the second lens group G₆₂ functions as a stabilizing group VC₆ and blur is corrected by moving the stabilizing group VC₆ in a direction that is substantially orthogonal to the optical axis.

Here, values of various types of data related to the zoom lens according to the sixth embodiment are given.

F number=3.60 (wide angle end) to 5.00 (intermediate focus position) to 5.74 (telephoto end)
Focal length of entire zoom lens system=28.53 (fw: wide angle end) to 45.02 (intermediate focus position) to 68.23 (ft: telephoto end)
Half angle of view (ω)=37.17 (wide angle end) to 25.67 (intermediate focus position) to 17.59 (telephoto end)

(Lens data)

| | | | |
|---|---|---|---|
| r₁ = 40.000 | d₁ = 1.500 | nd₁= 1.9108 | νd₁ = 35.25 |
| r₂ = 20.250 | d₂ = 10.810 | | |
| r₃ = −77.500 | d₃ = 1.200 | nd₂ = 1.4875 | νd₂ = 70.44 |
| r₄ = 45.700 | d₄ = 2.018 | | |
| r₅ = 34.500 | d₅ = 3.150 | nd₃ = 1.8467 | νd₃ = 23.78 |
| r₆ = 78.600 | d₆ = D(6) | | |
| | (variable) | | |
| r₇ = 19.587 | d₇ = 3.420 | nd₄ = 1.5533 | νd₄ = 71.68 |
| (aspheric) | | | |
| r₈ = 516.045 | d₈ = 2.780 | | |
| (aspheric) | | | |
| r₉ = ∞ | d₉ = 2.000 | | |
| (aperture stop) | | | |
| r₁₀ = 16.350 | d₁₀ = 3.500 | nd₅ = 1.4970 | νd₅ = 81.61 |
| r₁₁ = −1000.000 | d₁₁ = 1.000 | nd₆ = 1.7015 | νd₆ = 41.15 |
| r₁₂ = 13.470 | d₁₂ = 6.453 | | |
| r₁₃ = 24.333 | d₁₃ = 2.950 | nd₇ = 1.4971 | νd₇ = 81.56 |
| (aspheric) | | | |
| r₁₄ = −60.233 | d₁₄ = D(14) | | |
| (aspheric) | (variable) | | |
| r₁₅ = −46.142 | d₁₅ = 1.000 | nd₈ = 1.5312 | νd₈ = 56.04 |
| (aspheric) | | | |
| r₁₆ = −156.577 | d₁₆ = D(16) | | |
| (aspheric) | (variable) | | |
| r₁₇ = −62.140 | d₁₇ = 1.500 | nd₉ = 1.5168 | νd₉ = 64.20 |
| r₁₈ = −155.400 | d₁₈ = D(18) | | |
| | (variable) | | |
| r₁₉ = ∞ | d₁₉ = 3.100 | nd₁₀ = 1.5168 | νd₁₀ = 64.20 |
| r₂₀ = ∞ | d₂₀ = 1.000 | | |
| r₂₁ = ∞ | | | |
| (image plane) | | | |

Constant of the conic (k) and aspheric coefficients (A₄, A₆, A₈, A₁₀)
(Seventh order)
k = 0, A₄ = −2.5937 × 10⁻⁶, A₆ = 4.5235 × 10⁻⁸, A₈ = −8.0776 × 10⁻¹⁰,
A₁₀ = 4.1238 × 10⁻¹²
(Eighth order)
k = 0, A₄ = 9.3665 × 10⁻⁶, A₆ = 5.2017 × 10⁻⁸, A₈ = −1.0906 × 10⁻⁹,
A₁₀ = 6.0391 × 10⁻¹²
(Thirteenth order)
k = 0, A₄ = 3.1487 × 10⁻⁵, A₆ = 3.2377 × 10⁻⁷, A₈ = −3.5141 × 10⁻⁹,
A₁₀ = 6.2165 × 10⁻¹¹
(Fourteenth order)
k = 0, A₄ = 4.3267 × 10⁻⁵, A₆ = 4.0993 × 10⁻⁷, A₈ = −4.2612 × 10⁻⁹,
A₁₀ = 7.2861 × 10⁻¹¹
(Fifteenth order)
k = 0, A₄ = 1.2803 × 10⁻⁴, A₆ = −5.5306 × 10⁻⁷, A₈ = 4.0891 × 10⁻⁹,
A₁₀ = −4.8345 × 10⁻¹²
(Sixteenth order)
k = 0, A₄ = 1.3074 × 10⁻⁴, A₆ = −5.0428 × 10⁻⁷, A₈ = 3.2774 × 10⁻⁹,
A₁₀ = 3.1137 × 10⁻¹²

(Zoom data)

| | | Intermediate | |
|---|---|---|---|
| | Wide angle end | focus position | Telephoto end |
| D(6) | 28.943 | 11.734 | 1.500 |
| D(14) | 5.233 | 4.995 | 5.028 |
| D(16) | 14.937 | 15.165 | 15.139 |
| D(18) | 13.502 | 26.720 | 45.250 |

(Values related to conditional expression (1))
β4T (lateral magnification of fourth lens group G₆₄ at telephoto end)=1.247
(Values related to conditional expression (2))
f4 (focal length of fourth lens group G₆₄)=−201.462

$$\frac{\vert f 4 \vert}{\sqrt{( fw \times f t )}} - 4.566$$

(Values related to conditional expression (3))
f3 (focal length of third lens group G₆₃)=−123.554

$$\frac{\vert f 3 \vert}{\sqrt{( fw \times f t )}} - 2.800$$

(Values related to conditional expression (4))
fv (focal length of stabilizing group VC₆)=35.273

$$\frac{fv}{\sqrt{( fw \times f t )}} = 0.799$$

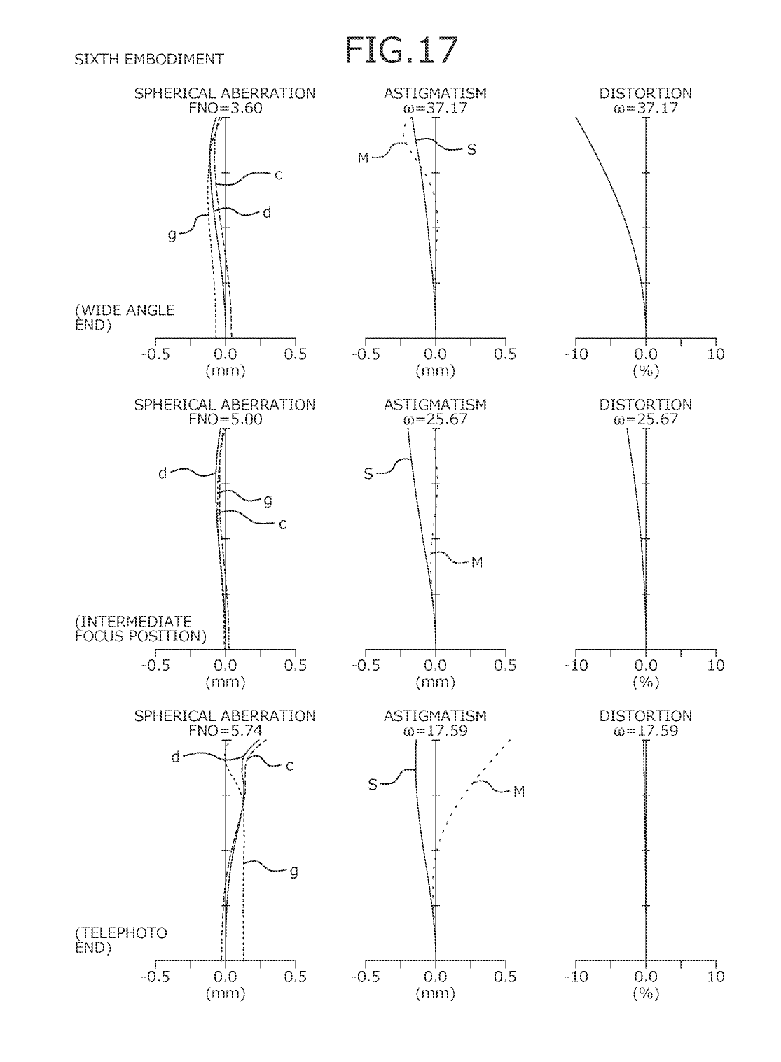

FIG. 17 is a diagram of various types of longitudinal aberration occurring in the zoom lens according to the sixth embodiment. In the diagram, for curves depicting spherical aberration, the vertical axis represents the F number (FNO), solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to the c-line (λ=656.28 nm). For curves depicting astigmatism, the vertical axis represents the half angle of view (ω), solid lines depict characteristics of the sagittal plane (S), and dashed lines depict characteristics of the meridional plane (M). For curves depicting distortion, the vertical axis represents the half angle of view (ω).

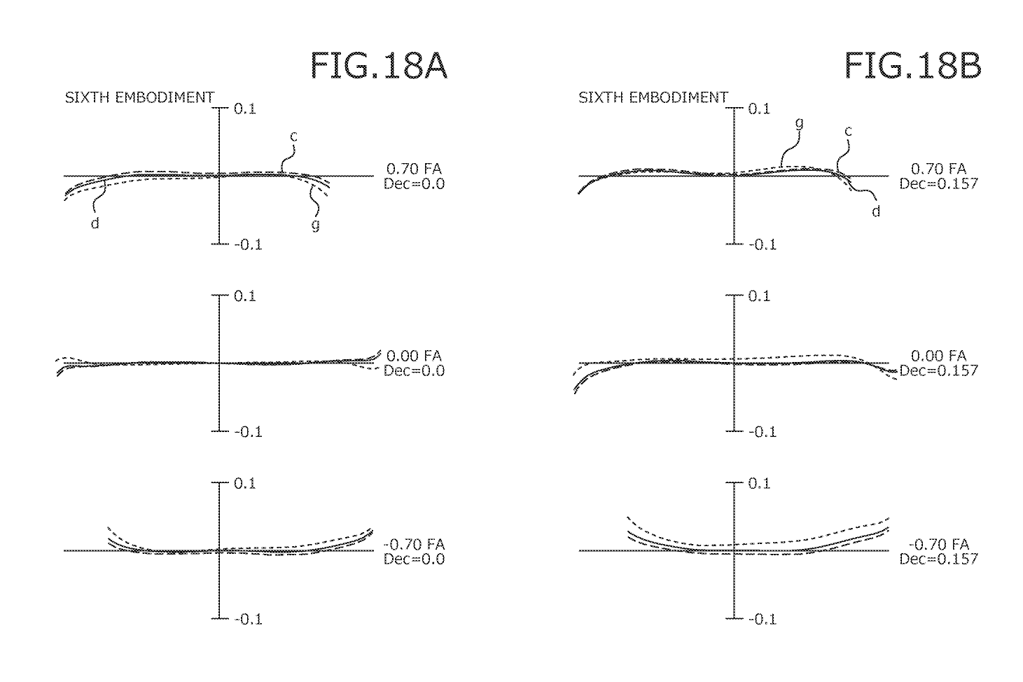

FIGS. 18A and 18B are diagrams of various types of transverse aberration occurring at the telephoto end of the zoom lens according to the sixth embodiment. FIG. 18A depicts a reference state where blur is not corrected at the telephoto end and FIG. 18B depicts a state where blur is corrected at the telephoto end, by moving the stabilizing group VC₆ 0.157 mm in a direction that is substantially orthogonal to the optical axis. Image displacement when the object distance is ∞ and the zoom lens is tilted 0.3 degrees at the telephoto end is equivalent to the image displacement when the stabilizing group VC₆ is moved 0.157 mm parallel to the direction that is substantially orthogonal to the optical axis.

In FIGS. 18A and 18B, an upper portion depicts transverse aberration at an image point corresponding to 70% of the maximum image height, a middle portion depicts transverse aberration at an image point on the optical axis, and a lower portion depicts transverse aberration at an image point corresponding to −70% of the maximum image height. In the figures, the horizontal axis represents the distance from the principal ray on the pupil plane, solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to the c-line (λ=656.28 nm).

From the figures depicting transverse aberration, it is clear that the symmetry of the transverse aberration at the image point on the optical axis is favorable. Further, comparison of the transverse aberration at the +70% image point and the transverse aberration at the −70% image point with the reference state reveals that for both, curvature is minimal and since the slopes of the aberration curves are substantially equivalent, eccentric comatic aberration and eccentric astigmatism are minimal, indicating that even in a state where blur is corrected, sufficient imaging performance can be obtained.

Further, when the blur correction angles of the zoom lens are the same, the focal length of the entire zoom lens system becomes shorter and the amount of parallel movement necessary for blur correction is reduced. Therefore, at any of the zoom positions, for blur correction angles up to 0.3 degrees, sufficient blur correction is possible without causing imaging properties to drop. Further, the blur correction angle can be increased to be greater than 0.3 degrees by applying the amount of parallel movement of the stabilizing group VC₆ at the telephoto end to the wide angle end and intermediate focus positions.

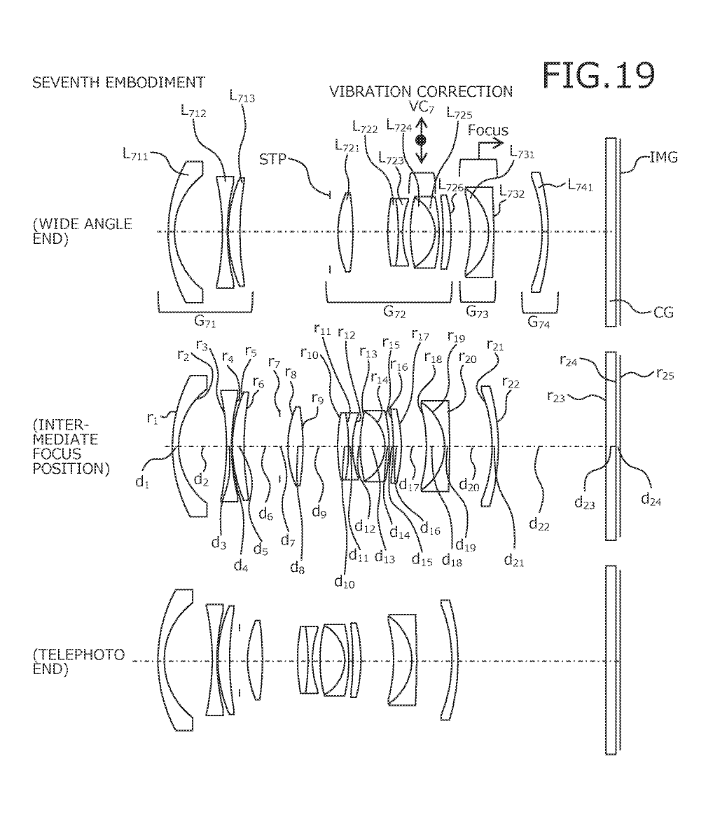

FIG. 19 is a diagram depicting, along the optical axis, a configuration of the zoom lens according to a seventh embodiment. The zoom lens includes sequentially from the object side nearest a non-depicted object, a first lens group G₇₁ having a negative refractive power, a second lens group G₇₂ having a positive refractive power, a third lens group G₇₃ having a negative refractive power, and a fourth lens group G₇₄ having a negative refractive power. The cover glass CG is disposed between the fourth lens group G₇₄ and the image plane IMG.

The first lens group G₇₁ includes sequentially from the object side, a negative lens L₇₁₁, a negative lens L₇₁₂, and a positive lens L₇₁₃.

The second lens group G₇₂ includes sequentially from the object side, the aperture stop STP prescribing a given aperture, a positive lens L₇₂₁, a positive lens L₇₂₂, a negative lens L₇₂₃, a positive lens L₇₂₄, a negative lens L₇₂₅, and a positive lens L₇₂₆. Both surfaces of the positive lens L₇₂₁ and of the positive lens L₇₂₄ are aspheric. The positive lens L₇₂₂ and the negative lens L₇₂₃ are cemented. The positive lens L₇₂₄ and the negative lens L₇₂₅ are cemented.

The third lens group G₇₃ includes sequentially from the object side, a positive lens L₇₃₁ and a negative lens L₇₃₂. The positive lens L₇₃₁ and the negative lens L₇₃₂ are cemented. The surface on the image plane IMG side of the negative lens L₇₃₂ is aspheric.

The fourth lens group G₇₄ is configured by a negative lens L₇₄₁.

In the zoom lens, the second lens group G₇₂, the third lens group G₇₃, and the fourth lens group G₇₄ are moved along the optical axis, from the image plane IMG side toward the object side during zooming from the wide angle end to the telephoto end. During zooming, the second lens group G₇₂ and the fourth lens group G₇₄ move along loci of the same shape such that the respective distances moved by the second lens group G₇₂ and the fourth lens group G₇₄ are equal. From the wide angle end to a vicinity of an intermediate focus position, the first lens group G₇₁ moves along the optical axis, from the object side toward the image plane IMG side; and from a vicinity of an intermediate focus position to the telephoto end, the first lens group G₇₁ moves along the optical axis, from the image plane IMG side toward the object side. The interval between the first lens group G₇₁ and the second lens group G₇₂ decreases during zooming from the wide angle end to the telephoto end.

In the zoom lens, focusing from a focused state at infinity to a focused state at the minimum object distance is performed by moving the third lens group G₇₃ along the optical axis, from the object side toward the image plane IMG side. Further, a cemented lens formed by the positive lens L₇₂₄ and the negative lens L₇₂₅ in the second lens group G₇₂ functions as a stabilizing group VC₇ and blur is corrected by moving the stabilizing group VC₇ in a direction that is substantially orthogonal to the optical axis.

Here, values of various types of data related to the zoom lens according to the seventh embodiment are given.

F number=3.60 (wide angle end) to 5.00 (intermediate focus position) to 5.77 (telephoto end)
Focal length of entire zoom lens system=29.76 (fw: wide angle end) to 44.98 (intermediate focus position) to 58.16 (ft: telephoto end)
Half angle of view (ω)=37.04 (wide angle end) to 25.84 (intermediate focus position) to 20.39 (telephoto end)

(Lens data)

| | | | |
|---|---|---|---|
| r₁ = 35.563 | d₁ = 1.500 | nd₁ = 1.9004 | νd₁ = 37.37 |
| r₂ = 17.280 | d₂ = 11.684 | | |
| r₃ = −60.895 | d₃ = 1.200 | nd₂ = 1.4875 | νd₂ = 70.44 |
| r₄ = 48.235 | d₄ = 0.200 | | |
| r₅ = 31.884 | d₅ = 2.862 | nd₃ = 1.9212 | νd₃ = 23.96 |
| r₆ = 71.184 | d₆ = D(6) | | |
| | (va riable) | | |
| r₇ = ∞ | d₇ = 2.000 | | |
| (aperture stop) | | | |
| r₈ = 23.917 | d₈ = 3.628 | nd₄ = 1.5891 | νd₄ = 61.25 |
| (aspheric) | | | |
| r₉ = −60.294 | d₉ = 8.484 | | |
| (aspheric) | | | |
| r₁₀ = 41.308 | d₁₀ = 2.618 | nd₅ = 1.4970 | νd₅ = 81.61 |
| r₁₁ = −48.273 | d₁₁ = 1.000 | nd₆ = 1.8061 | νd₆ = 33.27 |
| r₁₂ = 21.547 | d₁₂ = 1.878 | | |
| r₁₃ = 34.304 | d₁₃ = 6.012 | nd₇ = 1.5533 | νd₇ = 71.68 |
| (aspheric) | | | |
| r₁₄ = −9.545 | d₁₄ = 1.000 | nd₈ = 1.5710 | νd₈ = 50.80 |
| r₁₅ = −36.085 | d₁₅ = 1.000 | | |
| (aspheric) | | | |
| r₁₆ = −61.965 | d₁₆ = 1.936 | nd₉ = 1.9229 | νd₉ = 20.88 |
| r₁₇ = −35.436 | d₁₇ = D(17) | | |
| | (variable) | | |
| r₁₈ = −35.485 | d₁₈ = 4.438 | nd₁₀ = 1.9229 | νd₁₀ = 20.88 |
| r₁₉ = −12.677 | d₁₉ = 1.200 | nd₁₁ = 1.8211 | νd₁₁ = 24.06 |
| r₂₀ = −163.679 | d₂₀ = D(20) | | |
| (aspheric) | (variable) | | |
| r₂₁ = −35.081 | d₂₁ = 1.500 | nd₁₂ = 1.8061 | νd₁₂ = 40.73 |
| r₂₂ = −51.150 | d₂₂ = D(22) | | |
| | (variable) | | |
| r₂₃ = ∞ | d₂₃ = 2.500 | nd₁₃ = 1.5168 | νd₁₃ = 64.20 |
| r₂₄ = ∞ | d₂₄ = 1.000 | | |
| r₂₅ = ∞ | | | |
| (image plane) | | | |

Constant of the conic (k) and aspheric coefficients (A₄, A₆, A₈, A₁₀)
(Eighth order)
k = 0, A₄ = −7.6555 × 10⁻⁶, A₆ = −9.7518 × 10⁻⁹, A₈ = 6.5377 × 10⁻¹⁰,
A₁₀ = −1.4553 × 10⁻¹²
(Ninth order)
k = 0, A₄ = 6.7019 × 10⁻⁶, A₆ = 1.2957 × 10⁻⁹, A₈ = 5.7520 × 10⁻¹⁰,
A₁₀ = −1.118 5 × 10⁻¹²
(Thirteenth order)
k = 0, A₄ = −3.3041 × 10⁻⁶, A₆ = −2.7071 × 10⁻⁸, A₈ = 5.9181 × 10⁻¹⁰,
A₁₀ = −2.8654 × 10⁻¹²
(Twentieth order)
k = 0, A₄ = 6.2507 × 10⁻⁶, A₆ = 3.1161 × 10⁻⁹, A₈ = −2.8781 × 10⁻¹¹,
A₁₀ = 4.2996 × 10⁻¹³

(Zoom data)

| | | Intermediate | |
|---|---|---|---|
| | Wide angle end | focus position | Telephoto end |
| D(6) | 21.862 | 8.685 | 2.387 |
| D(17) | 4.693 | 6.151 | 7.951 |
| D(20) | 11.808 | 10.347 | 8.555 |
| D(22) | 14.000 | 26.183 | 35.949 |

(Values related to conditional expression (1))
β4T (lateral magnification of fourth lens group G₇₄ at telephoto end)=1.285
(Values related to conditional expression (2))
f4 (focal length of fourth lens group G₇₄)=−144.547

$$\frac{\vert f 4 \vert}{\sqrt{( fw \times f t )}} = 3.474$$

(Values related to conditional expression (3))
f3 (focal length of third lens group G₇₃)=−82.467

$$\frac{\vert f 3 \vert}{\sqrt{( fw \times f t )}} = 1.982$$

(Values related to conditional expression (4))
fv (focal length of stabilizing group VC₇)=34.382

$$\frac{fv}{\sqrt{( fw \times f t )}} = 0.826$$

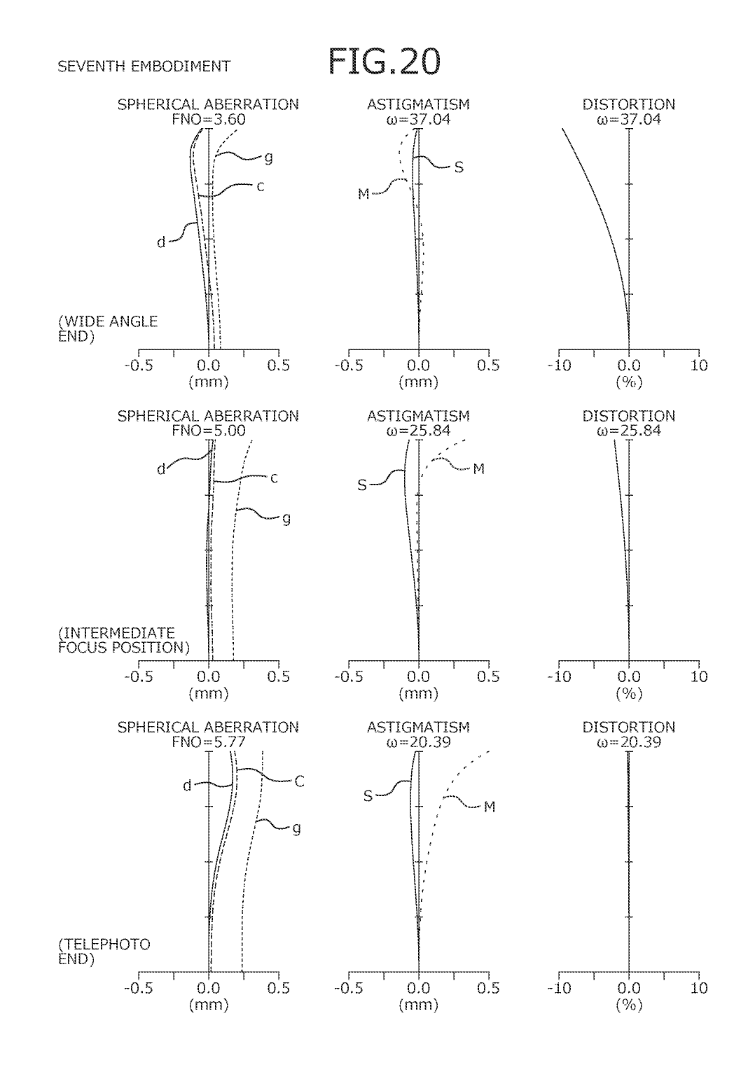

FIG. 20 is a diagram of various types of longitudinal aberration occurring in the zoom lens according to the seventh embodiment. In the diagram, for curves depicting spherical aberration, the vertical axis represents the F number (FNO), solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to the c-line (λ=656.28 nm). For curves depicting astigmatism, the vertical axis represents the half angle of view (ω), solid lines depict characteristics of the sagittal plane (S), and dashed lines depict characteristics of the meridional plane (M). For curves depicting distortion, the vertical axis represents the half angle of view (ω).

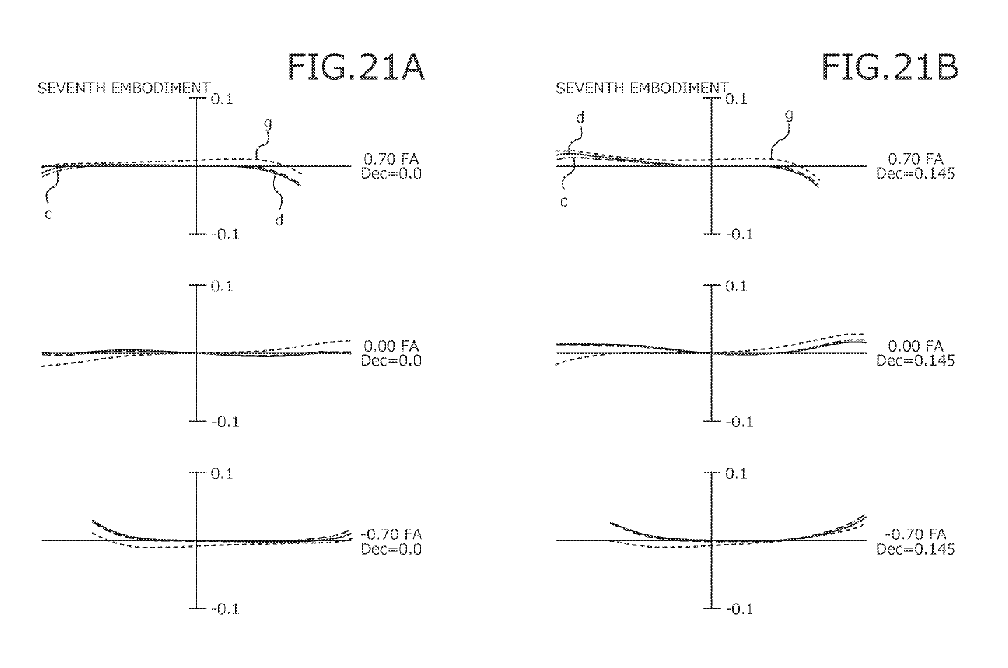

FIGS. 21A and 21B are diagrams of various types of transverse aberration occurring at the telephoto end of the zoom lens according to the seventh embodiment. FIG. 18A depicts a reference state where blur is not corrected at the telephoto end and FIG. 21B depicts a state where blur is corrected at the telephoto end, by moving the stabilizing group VC₇ 0.145 mm in a direction that is substantially orthogonal to the optical axis. Image displacement when the object distance is ∞ and the zoom lens is tilted 0.3 degrees at the telephoto end is equivalent to the image displacement when the stabilizing group VC₇ is moved 0.145 mm parallel to the direction that is substantially orthogonal to the optical axis.

In FIGS. 21A and 21B, an upper portion depicts transverse aberration at an image point corresponding to 70% of the maximum image height, a middle portion depicts transverse aberration at an image point on the optical axis, and a lower portion depicts transverse aberration at an image point corresponding to −70% of the maximum image height. In the figures, the horizontal axis represents the distance from the principal ray on the pupil plane, solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to the c-line (λ=656.28 nm).

From the figures depicting transverse aberration, it is clear that the symmetry of the transverse aberration at the image point on the optical axis is favorable. Further, comparison of the transverse aberration at the +70% image point and the transverse aberration at the −70% image point with the reference state reveals that for both, curvature is minimal and since the slopes of the aberration curves are substantially equivalent, eccentric comatic aberration and eccentric astigmatism are minimal, indicating that even in a state where blur is corrected, sufficient imaging performance can be obtained.

Further, when the blur correction angles of the zoom lens are the same, the focal length of the entire zoom lens system becomes shorter and the amount of parallel movement necessary for blur correction is reduced. Therefore, at any of the zoom positions, for blur correction angles up to 0.3 degrees, sufficient blur correction is possible without causing imaging properties to drop. Further, the blur correction angle can be increased to be greater than 0.3 degrees by applying the amount of parallel movement of the stabilizing group VC₇ at the telephoto end to the wide angle end and intermediate focus positions.

Among the values for each of the embodiments, r₂, . . . indicate the radius of curvature of lens surfaces, aperture surface, etc.; d₁, d₂, . . . indicate the thickness of the lenses, the aperture, etc. or the interval between the surfaces thereof; nd₁, nd₂, . . . indicate the refraction index of the lenses with respect to the d-line (λ=546.074 nm); and υd₁, υd₂, . . . indicate the Abbe number for the d-line (λ=587.56 nm) of the lenses. Lengths are indicated in units of “mm”; and angles are indicated in “degrees”.

Each aspheric surface shape above is expressed by the equation below; where, Z is the depth of the aspheric surface, c(l/r) is curvature; h is the height from the optical axis; k is the constant of the conic; A₄, A₆, A₈, A₁₀ are respectively fourth order, sixth order, eighth order, and tenth order aspheric coefficients; and the travel direction of light is assumed to be positive.

$$Z = \frac{{ch}^{2}}{1 + \sqrt{1 - ( 1 + k ) {c}^{2} {h}^{2}}} + {A}_{4} {h}^{4} + {A}_{6} {h}^{6} + {A}_{8} {h}^{8} + {A}_{10} {h}^{10} \qquad [ 1 ]$$

As described, the zoom lens according to the embodiments satisfies the conditional expressions above, whereby the overall length of the optical system is shortened, the distance that the focusing group is moved during focusing is suppressed, and changes in the reproduction ratio consequent variation of the angle of view during wobbling are suppressed. Further, reductions in the size and weight of the focusing group are facilitated, enabling favorable high-speed focusing. The correction of various types of aberration during focusing also becomes favorable. Shifting of lens centers of lens groups with respect to one another, potentially occurring with zooming, is suppressed, enabling degradation of optical performance occurring with repeated use to be suppressed. Furthermore, reduction of the size and weight of the stabilizing group is facilitated, enabling favorable optical performance to be maintained even during blur correction. Reduction of the diameter of the optical system can also be facilitated. In addition, aberration correction capacity can be improved by disposing lenses or cemented lenses having suitably formed aspheric surfaces.

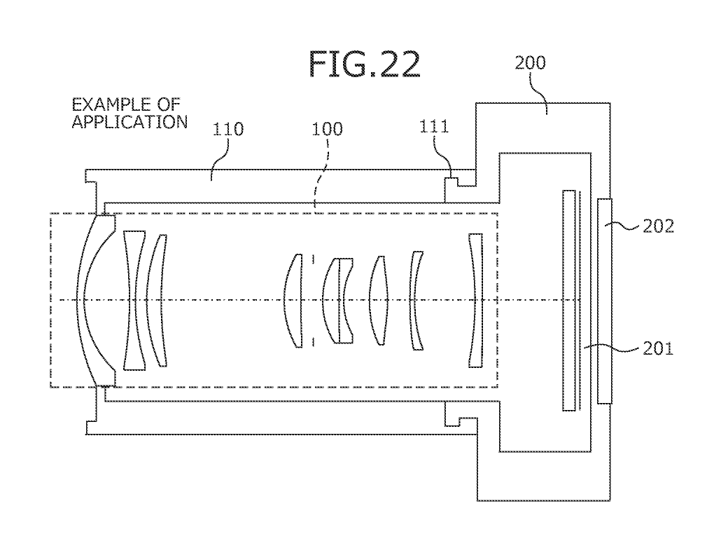

An example of application of the zoom lens in the first to seventh embodiments, to an imaging apparatus will be described. FIG. 22 is a diagram depicting an application example of the imaging apparatus equipped with the zoom lens according to the present invention. FIG. 22 depicts a state where a lens barrel 110 equipped with a zoom lens 100 is attached to an imaging apparatus 200.

The zoom lens 100 is the zoom lens of the first to seventh embodiments. The lens barrel 110 is detachable from the imaging apparatus 200 via a mounting unit 111. A screw-type, bayonet-type, etc. mount is used as the mounting unit 111. In the example, a bayonet-type mount is used.

Images captured by the zoom lens 100 are formed on the imaging surface of an image sensor 201 (CCD, CMOS, etc.) disposed in the imaging apparatus 200 and signals related to the images and output from the image sensor 201 are processed by a non-depicted signal processing circuit, whereby images are displayed on a display unit 202.

An imaging apparatus equipped with a compact, high-performance zoom lens and optimal for capturing video can be realized by the configuration above.

Although FIG. 22 depicts an example where the zoom lens according to the present invention is used in a mirrorless camera, the zoom lens is not limited to a mirrorless camera and can be used on interchangeable-lens cameras, digital still cameras, video cameras, and the like.

As described, the zoom lens according to the embodiments may be used on compact, interchangeable-lens imaging apparatuses such as mirrorless cameras and is particularly applicable to imaging apparatuses capable of capturing video.

According to one aspect of the embodiments, an effect is achieved in that a compact, high-performance zoom lens can be provided that has a small, light-weight focusing group, suppresses changes in the reproduction ratio consequent to variation of the angle of view during wobbling, and can perform favorable high-speed focusing. In addition, an effect is achieved in that an imaging apparatus can be provided that is equipped with a compact, high-performance zoom lens.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

This application is based upon and claims the benefit of priority of the prior Japanese Patent Application No. 2014-223537, filed on Oct. 31, 2014, the entire contents of which are incorporated herein by reference.

What is claimed is:

1. A zoom lens comprising sequentially from an object side:
a first lens group having a negative refractive power;
a second lens group having a positive refractive power;
a third lens group having a negative refractive power; and
a fourth lens group having a negative refractive power, wherein
the first lens group, the second lens group, the third lens group, and the fourth lens group are moved along an optical axis to zoom from a wide angle end to telephoto end and such that an interval between the first lens group and the second lens group decreases and distances that the second lens group and the fourth lens group are moved are equivalent, and
the third lens group is moved along the optical axis, toward an image side to focus from a focused state at infinity to a focused state at a minimum object distance.

2. The zoom lens according to claim 1, wherein
the zoom lens satisfies a conditional expression (1) 1.06≦β4T≦3.00, where, β4T represents lateral magnification of the fourth lens group at the telephoto end.

3. The zoom lens according to claim 1, wherein the zoom lens satisfies a conditional expression (2)
$$1.20 \leq \frac{\vert f 4 \vert}{\sqrt{( fw \times f t )}} \leq 10.00$$
where, f4 represents a focal length of the fourth lens group, fw represents a focal length of the entire optical system at the wide angle end, and ft represents the focal length of the entire optical system at the telephoto end.

4. The zoom lens according to claim 1, wherein
the zoom lens satisfies a conditional expression (3)
$$0.70 \leq \frac{\vert f 3 \vert}{\sqrt{( fw \times f t )}} \leq 5.00$$
where, f3 represents a focal length of the third lens group, fw represents the focal length of the entire optical system at the wide angle end, and ft represents the focal length of the entire optical system at the telephoto end.

5. The zoom lens according to claim 1, wherein
the second lens group has a stabilizing group that is moved in a direction that is substantially orthogonal to the optical axis and corrects blur, and
the zoom lens satisfies a conditional expression (4)
$$0.30 \leq \frac{fv}{\sqrt{( fw \times f t )}} \leq 1.10$$
wherein, fv represents a focal length of the stabilizing group, fw represents the focal length of the entire optical system at the wide angle end, and ft represents the focal length of the entire optical system at the telephoto end.

6. An imaging apparatus comprising:
a zoom lens; and
an image sensor configured to convert an optical image formed by the zoom lens into an electrical signal, wherein
the zoom lens includes sequentially from an object side:
a first lens group having a negative refractive power;
a second lens group having a positive refractive power;
a third lens group having a negative refractive power; and
a fourth lens group having a negative refractive power,
the first lens group, the second lens group, the third lens group, and the fourth lens group are moved along an optical axis to zoom from a wide angle end to telephoto end and such that an interval between the first lens group and the second lens group decreases and distances that the second lens group and the fourth lens group are moved are equivalent, and
the third lens group is moved along the optical axis, toward an image side to focus from a focused state at infinity to a focused state at a minimum object distance.
